(19) United States
(12) Patent Application Publication
(10) Pub. No.: US 2012/0140161 A1
(43) Pub. Date: Jun. 7, 2012

(54) POLYMER FILM, RETARDATION FILM, POLARIZING PLATE, LIQUID CRYSTAL DISPLAY DEVICE AND ULTRAVIOLET ABSORBER

(75) Inventors: Shigeaki NIMURA, Kanagawa (JP); Ryo Nakamura, Kanagawa (JP); Shunya Katoh, Kanagawa (JP); Masayoshi Toyoda, Kanagawa (JP); Hiroko Kamee, Kanagawa (JP); Masuji Motoki, Kanagawa (JP); Masaki Noro, Kanagawa (JP); Hiroshi Inada, Kanagawa (JP)

(73) Assignee: FUJIFILM Corporation, Tokyo (JP)

(21) Appl. No.: 13/305,348

(22) Filed: Nov. 28, 2011

(30) Foreign Application Priority Data
Dec. 1, 2010 (JP) 2010-268492
Jun. 21, 2011 (JP) 2011-137004

(51) Int. Cl. F21V 9/06; G02B 5/30; G02B 1/08

(52) U.S. Cl. 349/194; 252/589; 359/492.01

(57) ABSTRACT

A polymer film, containing a merocyanine compound having λₘₐₓ of not longer than 375 nm, and a compound represented by formula (II), which is different from said at least one merocyanine compound, is disclosed. In the formula, R¹ and R² each independently represent a hydrogen atom, alkyl group, aryl group, heterocyclic group, cyano, N-alkyl- or N-aryl carbamoyl group, aryloxy carbonyl group or —CH₂COOR⁵, or R¹ and R² bind to each other to form a ring containing a nitrogen atom; R⁵ represents an alkyl group, aryl group or a heterocyclic group; R³ and R⁴ each independently represent a substituent having a Hammett substituent constant σp of equal to or more than 0.2, or R³ and R⁴ bind to each other to form a cyclic active methylene compound structure.

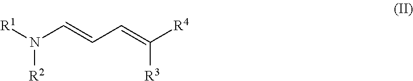

### CROSS-REFERENCE TO RELATED APPLICATIONS

The present application claims the benefit of priority from Japanese Patent Applications No. 2010-268492, filed on Dec. 1, 2010, and No. 2011-137004, filed on Jun. 21, 2011, the contents of which are herein incorporated by reference in their entirety.

### BACKGROUND OF THE INVENTION

1. Field of the Invention

The present invention relates to a colorless polymer film which is excellent in light-resistance, to a retardation film, polarizing plate and liquid crystal display device having it, and to an ultraviolet absorber which is excellent in light-resistance.

2. Background Art

It is known that for developing the ultraviolet absorption ability, an ultraviolet absorber is added to a polymer film to be used in various applications such as a protective film. And a biaxial film, of which Re shows the reversed wavelength dispersion and of which Rth shows the normal wavelength dispersion, is useful as a retardation film to be used in a liquid crystal display device, and for preparing the films having such characteristics, addition of an ultraviolet absorber has been tried.

The polymer film containing the merocyanine compound as an ultraviolet absorber is proposed in JP-A-8-239509. And the polymer material containing the merocyanine compound as an ultraviolet absorber, the molded article formed of the material, and the coating-type ultraviolet absorption layer are proposed in JP-A-2009-67973. And using the merocyanine compound as a wavelength-dispersion controlling agent of a polymer film is also proposed in JP-A-2009-64006 and JP-A-2009-64007.

On the other hand, it is known that the light-resistances and ultraviolet-absorption abilities of known merocyanine-base ultraviolet absorbers are decreased with time. For example, in JP-A-2009-270062, 2009-79213 and 2009-67983, it is proposed that another ultraviolet absorber is used along with the merocyanine-base ultraviolet absorber in order to improve the light resistance.

However, yellowish discoloration is sometimes caused by addition of these ultraviolet absorbers, which may be detrimental for the members used in display devices.

Development of colorless polymer films or the like, which are excellent in light resistance, is needed.

### SUMMARY OF THE INVENTION

One object of the present invention is to provide a colorless polymer film having a high light resistance, and a retardation film, polarizing plate and liquid crystal display device using it.

Another object of the invention is to provide an ultraviolet absorber having a high light resistance.

The means for achieving the above-described objects are as follows.

[1] A polymer film comprising

at least one merocyanine compound having λₘₐₓ of not longer than 375 nm, and

at least one compound represented by formula (II), which is different from said at least one merocyanine compound:

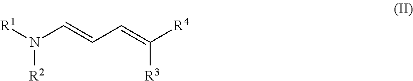

wherein, in formula (II), R¹ and R² each independently represent a hydrogen atom, alkyl group, aryl group, heterocyclic group, cyano, N-alkyl- or N-aryl carbamoyl group, aryloxy carbonyl group or —CH₂COOR⁵, or R¹ and R² bind to each other to form a ring containing a nitrogen atom, these groups and rings may have one or more substituents if possible; R⁵ represents an alkyl group, aryl group or a heterocyclic group; R³ and R⁴ each independently represent a substituent having a Hammett substituent constant σp of equal to or more than 0.2, or R³ and R⁴ bind to each other to form a cyclic active methylene compound structure, and these groups and rings may have one or more substituents if possible.

[2] The polymer film of [1], wherein said at least one merocyanine compound having λₘₐₓ of not longer than 375 nm is a compound represented by formula (I):

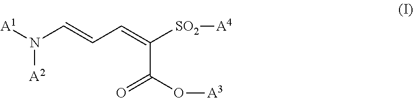

wherein, in formula (I), A¹, A², A³ and A⁴ each independently represent a hydrogen atom, alkyl group, alkenyl group or aryl group, or A′ and A² bind to each other to form a ring, and these groups and rings may have one or more substituents if possible.

[3] The polymer film of [1] or [2], wherein the residual amounts of the at least one merocyanine compound having λₘₐₓ of not longer than 375 nm and the at least one compound represented by formula (II) are equal to or more than 80% respectively after being subjected to an irradiation of light with an irradiance of 150 W/m² for 200 hours.
[4] The polymer film of [2] or [3], wherein the compound represented by formula (I) is a compound represented by formula (I-a):

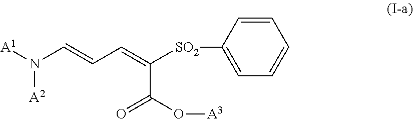

wherein, in formula (I-a), the definitions of A¹, A² and A³ are same as those of A¹, A² and A³ in formula (I) respectively.

[5] The polymer film of any one of [1]-[4], wherein the at least one compound represented by formula (II) is a compound represented by formula (II-a), (II-b), (II-c), or (II-d):

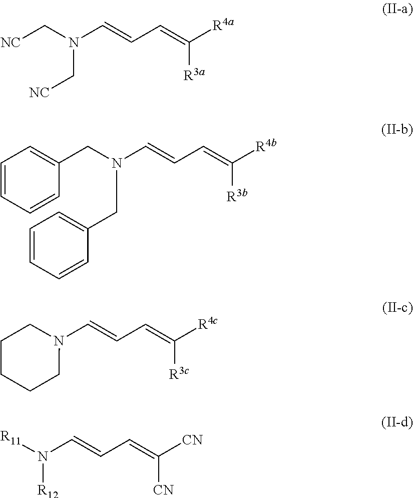

wherein, in formulas (II-a), (II-b), and (II-c), the definitions of R^{3a}, R^{3b} and R^{3c} are same as that of R³ in formula (II); and the definitions of R^{4a}, R^{4b} and R^{4c} are same as that of R⁴ in formula (II); and, in formula (II-d), the definitions of R¹¹ and R¹² are same as those of R¹ and R² in formula (II).

[6] The polymer film of any one of [1]-[5], wherein, in formula (II), R³ and R⁴ each independently represent a substituted or non-substituted alkyl- or aryl-carbonyl group, a substituted or non-substituted alkyl- or aryl-oxycarbonyl group, a substituted or non-substituted N-alkyl or N-aryl carbamoyl group or cyano, or R³ and R⁴ bind to each other to form a ring selected from Cyclic Active Methylene Group (I):

### Cyclic Active Methylene Group (I)

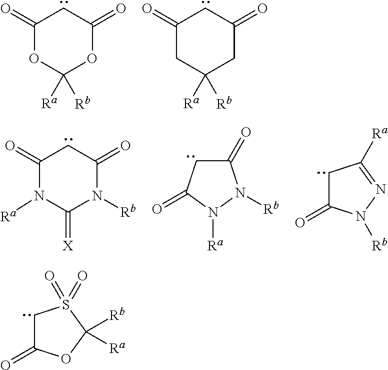

wherein each of “**” indicates the position at which the group binds to formula (II); R^{a} and R^{b} each represent a hydrogen atom, a substituted or non-substituted alkyl group or a substituted or non-substituted phenyl group, or R^{a} and R^{b} bind to each other to form a ring structure; and X represents an oxygen atom or a sulfur atom.

[7] The polymer film of any one of [1]-[6], wherein the at least one compound represented by formula (II) has λₘₐₓ of not shorter than 350 nm.
[8] The polymer film of any one of [1]-[7], wherein a total amount of the at least one compound, having λₘₐₓ of not longer than 375 nm, is from 0.2 to 10 parts by mass with respect to the total of the polymer film.
[9] The polymer film of any one of [1]-[8], wherein a total amount of the at least one compound represented by formula (II) is from 0.2 to 10 parts by mass with respect to the total of the polymer film.
[10] The polymer film of any one of [1]-[9], wherein a ratio by mass of the at least one compound represented by formula (II) to the at least one compound, having λₘₐₓ of not longer than 375 nm, is from 5/1 to 2/5.
[11] A retardation film comprising

a polymer film of any one of [1]-[10] and

an optically anisotropic layer of a cured liquid crystal composition.

[12] A polarizing plate comprising

a polymer film of any one of [1]-[10] or a retardation film of [11], and

a polarizing film.

[13] A liquid crystal display device comprising at least one of a polymer film of [1], a retardation film of [11], and a polarizing plate of [12].
[14] An ultraviolet absorber comprising

at least one merocyanine compound having λₘₐₓ of not longer than 375 nm, and

at least one compound represented by formula (II), which is different from said at least one merocyanine compound:

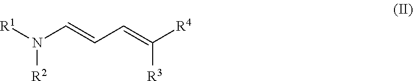

wherein, in formula (II), R¹ and R² each independently represent a hydrogen atom, alkyl group, aryl group, heterocyclic group, cyano, N-alkyl- or N-aryl carbamoyl group, aryloxy carbonyl group or —CH₂COOR⁵, or R¹ and R² bind to each other to form a ring containing a nitrogen atom, these groups and rings may have one or more substituents if possible; R⁵ represents an alkyl group, aryl group or a heterocyclic group; R³ and R⁴ each independently represent a substituent having a Hammett substituent constant σp of equal to or more than 0.2, or R³ and R⁴ bind to each other to form a cyclic active methylene compound structure, and these groups and rings may have one or more substituents if possible.

### BRIEF DESCRIPTION OF THE DRAWINGS

FIG. 1 is a schematic cross-sectional view of one embodiment of the retardation film of the invention.

FIG. 2 is a schematic cross-sectional view of one embodiment of the polarizing plate of the invention.

FIG. 3 is a schematic cross-sectional view of one embodiment of the liquid-crystal display device of the invention.

In the drawings, the meanings of the reference numerals are as follows:
10 Retardation Film
11 Optically Anisotropic Layer
12 Support (polymer film of the invention)
13 Polarizing Film
14 Protective Film
15 Polarizing Plate
16 Liquid-Crystal Cell
17 TN-Mode Liquid-Crystal Display Device

### DETAILED DESCRIPTION OF THE INVENTION

The present invention is described in detail below. In this description, the numerical range expressed by the wording “a number to another number” means the range including the former and latter numbers as lowermost and uppermost limits of the range respectively.

### 1. Polymer Film

The present invention relates to a polymer film containing at least one merocyanine compound having λₘₐₓ of not longer than 375 nm, and at least one compound represented by formula (II), which is different from said at least one merocyanine compound.

Both of the merocyanine compound, having λₘₐₓ of not longer than 375 nm, and the compound represented by formula (II) are merocyanine compounds having an ultraviolet absorption ability. The traditional merocyanine compounds to be used as an ultraviolet absorber are not sufficient in terms of the light resistance, and suffer from the time-dependent deterioration of the absorption ability. The present inventors have assiduously studied and, as a result, have found that the unpredictable effect of improving the light-resistance and reducing discoloration was obtainable by using the merocyanine compound, having λₘₐₓ of not longer than 375 nm, along with the compound represented by formula (II), which is different from the merocyanine compound. The detailed reason of obtaining the effect is uncertain, but, since one factor of the time-dependent deterioration of the absorption ability of the merocyanine compound is caused by the decomposition of the merocyanine compound with time, may reside in that the merocyanine compound represented by formula (II) is capable of preventing the decomposition of the merocyanine compound, having λₘₐₓ of not longer than 375 nm, which may result in improvement of the light-resistance.

Both of the merocyanine compound, having λₘₐₓ of not longer than 375 nm, and the compound represented by formula (II) may function 20, as not only an ultraviolet absorber but also an agent for controlling wavelength-dispersion of retardation. For an optical film to be used in a liquid crystal display device, it is important to adjust the wavelength dispersion characteristics of retardation to the appropriate range (for example, Rth(450)/Rth(550) is about 1.0 to about 1.5, where Rth(λ) means retardation along the thickness at a wavelength λ) in terms of improvement of the visual properties. If an amount of the merocyanine compound is too small, it may be difficult to obtain the ability of controlling the wavelength-dispersion characteristics along with the ability of ultraviolet absorption. On the other hand, if an amount of the merocyanine compound (especially, an amount of the merocyanine compound represented by formula (II)) is increased, the film may suffer from yellowish discoloration. According to the invention, since the merocyanine compound, having λₘₐₓ of not longer than 375 nm, is used along with the compound represented by formula (II), they may act synergistically; and therefore, by using them in a small amount which is not enough to cause any yellowish discoloration, it is possible to obtain not only the ability of ultraviolet absorption but also the ability of controlling the wavelength-dispersion characteristics.

The materials which can be used for preparing the polymer film of the invention will be described in detail.

### 1-(1) Polymer

The polymer to be used as a main ingredient of the polymer film of the invention is not limited. Any polymers which can be formed into a film may be used. Depending on the application thereof, it may be selected from various polymers. Examples of the polymer which can be used in the invention include cellulose series polymers such as cellulose triacetate; polycarbonate series polymers; polyester series polymers such as polyethylene terephthalate and polyethylene naphthalate; acryl series polymer such as polymethylmethacrylate; and styrene series polymers such as polystyrene and acrylonitrile-styrene copolymer (AS polymer). Examples of the polymer which can be used in the invention include also polyolefins such as polyethylene and polypropylene; polyolefin series polymer such as ethylene-propylene copolymer; vinyl chloride series polymers; amide series polymers such as nylon and aromatic polyamide; imide series polymers, sulfone series polymers; polyethersulfone series polymers; polyether ether ketone series polymers; polyphenylene sulfide series polymers; vinylidene chloride series polymers; vinyl alcohol series polymers; vinyl butyral series polymers; allylate series polymers; polyoxymethylene series polymers; epoxy series polymers; and any mixed polymers thereof.

1-(2) Merocyanine Compound with λₘₐₓ of not longer than 375 nm

The polymer film contains at least one merocyanine compound having λₘₐₓ of not longer than 375 nm. The term “λₘₐₓ” means a wavelength of absorption peak of the merocyanine compound.

The merocyanine compound, having λₘₐₓ of not longer than 375 nm, is not limited so far as it has λₘₐₓ of not longer than 375 nm. The merocyanine compound represented by formula (I) is preferable.

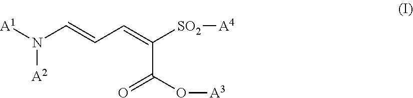

In formula (I), A′, A², A³ and A⁴ each independently represent a hydrogen atom, alkyl group, alkenyl group or aryl group, or A¹ and A² bind to each other to form a ring, and the ring may have at least one substituent if possible.

Examples of the substituent of each of A¹-A⁴ include a halogen atom (for example, a fluorine atom, a chlorine atom, a bromine atom, an iodine atom), an alkyl group (preferably an alkyl group having from 1 to 30 carbon atoms, more preferably from 1 to 10 carbon atoms, for example, a methyl group, an ethyl group, an n-propyl group, an isopropyl group, a tert-butyl group, an n-octyl group, a 2-ethylhexyl group), a cycloalkyl group (preferably a substituted or unsubstituted cycloalkyl group having from 3 to 30 carbon atoms, more preferably from 3 to 10 carbon atoms, for example, a cyclohexyl group, a cyclopentyl group, a 4-n-dodecylcyclohexyl group), a bicycloalkyl group (preferably a substituted or unsubstituted bicycloalkyl group having from 5 to 30 carbon atoms, more preferably from 5 to 10 carbon atoms, or that is, a monovalent group derived from a bicycloalkane preferably having from 5 to 30 carbon atoms, more preferably from 5 to 10 carbon atoms, by removing one hydrogen atom from it, for example, a bicyclo[1.2.2]heptan-2-yl group, a bicyclo[2.2.2]octan-3-yl group), an alkenyl group (preferably a substituted or unsubstituted alkenyl group having from 2 to 30 carbon atoms, more preferably from 2 to 10 carbon atoms, for example, a vinyl group, an allyl group), a cycloalkenyl group (preferably a substituted or unsubstituted cycloalkenyl group having from 3 to 30 carbon atoms, more preferably from 3 to 10 carbon atoms, of that is, a monovalent group derived from a cycloalkene preferably having from 3 to 30 carbon atoms, more preferably from 3 to 10 carbon atoms, by removing one hydrogen atom from it, for example, a 2-cyclopenten-1-yl group, a 2-cyclohexen-1-yl group), a bicycloalkenyl group (a substituted or unsubstituted bicycloalkenyl group, preferably a substituted or unsubstituted bicycloalkenyl group having from 5 to 30 carbon atoms, more preferably from 5 to 10 carbon atoms, or that is, a monovalent group derived from a bicycloalkene having one double bond, by removing one hydrogen atom from it, for example, a bicyclo[2.2.2]hept-2-en-1-yl group, a bicyclo[2.2.2]oct-2-en-4-yl group), an alkynyl group (preferably a substituted or unsubstituted alkynyl group having from 2 to 30 carbon atoms, more preferably from 2 to 10 carbon atoms, for example, an ethynyl group, a propargyl group), an aryl group (preferably a substituted or unsubstituted aryl group having from 6 to 30 carbon atoms, more preferably from 6 to 10 carbon atoms, for example, a phenyl group, a p-tolyl group, a naphthyl group), a heterocyclic group (preferably a monovalent group derived from a 5- or 6-membered, substituted or unsubstituted, aromatic or non-aromatic heterocyclic compound, by removing one hydrogen atom from it, more preferably a 5- or 6-membered aromatic heterocyclic group having from 3 to 30 carbon atoms, even more preferably having from 3 to 10 carbon atoms, for example, a 2-furyl group, a 2-thienyl group, a 2-pyrimidinyl group, a 2-benzothiazolyl group), a cyano group, a hydroxyl group, a nitro group, a carboxyl group, an alkoxy group (preferably a substituted or unsubstituted alkoxy group having from 1 to 30 carbon atoms, more preferably from 1 to 10 carbon atoms, for example, a methoxy group, an ethoxy group, an isopropoxy group, a tert-butoxy group, an n-octyloxy group, a 2-methoxyethoxy group), an aryloxy group (preferably a substituted or unsubstituted aryloxy group having from 6 to 30 carbon atoms, more preferably from 6 to 10 carbon atoms, for example, a phenoxy group, a 2-methylphenoxy group, a 4-tert-butylphenoxy group, a 3-nitrophenoxy group, a 2-tetradecanoylaminophenoxy group), a silyloxy group (preferably a silyloxy group having from 3 to 20 carbon atoms, more preferably from 3 to 10 carbon atoms, for example, a trimethylsilyloxy group, a tert-butyldimethylsilyloxy group), a heterocyclic-oxy group (preferably a substituted or unsubstituted heterocyclic-oxy group having from 2 to 30 carbon atoms, more preferably from 2 to 10 carbon atoms, for example, a 1-phenyltetrazol-5-oxy group, a 2-tetrahydropyranyloxy group), an acyloxy group (preferably a formyloxy group, a substituted or unsubstituted alkylcarbonyloxy group having from 2 to 30 carbon atoms, more preferably from 2 to 10 carbon atoms, a substituted or unsubstituted arylcarbonyloxy group having from 6 to 30 carbon atoms, more preferably from 6 to 10 carbon atoms, for example, an acetyloxy group, a pivaloyloxy group, a stearoyloxy group, a benzoyloxy group, a p-methoxyphenylcarbonyloxy group), a carbamoyloxy group (preferably a substituted or unsubstituted carbamoyloxy group having from 1 to 30 carbon atoms, more preferably from 1 to 10 carbon atoms, for example, an N,N-dimethylcarbamoyloxy group, an N,N-diethylcarbamoyloxy group, a morpholinocarbonyloxy group, an N,N-di-n-octylaminocarbonyloxy group, an N-n-octylcarbamoyloxy group), an alkoxycarbonyloxy group (preferably a substituted or unsubstituted alkoxycarbonyloxy group having from 2 to 30 carbon atoms, more preferably from 2 to 10 carbon atoms, for example, a methoxycarbonyloxy group, an ethoxycarbonyloxy group, a tert-butoxycarbonyloxy group, an n-octylcarbonyloxy group), an aryloxycarbonyloxy group (preferably a substituted or unsubstituted aryloxycarbonyloxy group having from 7 to 30 carbon atoms, more preferably from 7 to 10 carbon atoms, for example, a phenoxycarbonyloxy group, a p-methoxyphenoxycarbonyloxy group, a p-n-hexadecyloxyphenoxycarbonyloxy group), an amino group (preferably, an amino group, a substituted or unsubstituted alkylamino group having from 1 to 30 carbon atoms, more preferably from 1 to 10 carbon atoms, or a substituted or unsubstituted anilino group having 6 to 30 carbon atoms, more preferably from 6 to 10 carbon atoms, for example, a methylamino group, a dimethylamino group, an anilino group, an N-methylanilino group, a diphenylamino group), an acylamino group (preferably a formylamino group, a substituted or unsubstituted alkylcarbonylamino group having from 1 to 30 carbon atoms, more preferably from 1 to 10 carbon atoms, or a substituted or unsubstituted arylcarbonylamino group having from 6 to 30 carbon atoms, more preferably from 6 to 10 carbon atoms, for example, an acetylamino group, a pivaloylamino group, a lauroylamino group, a benzoylamino group), an aminocarbonylamino group (preferably a substituted or unsubstituted aminocarbonylamino group having from 1 to 30 carbon atoms, more preferably from 1 to 10 carbon atoms, for example, a carbamoylamino group, an N,N-dimethylaminocarbonylamino group, an N,N-diethylaminocarbonylamino group, a morpholinocarbonylamino group), an alkoxycarbonylamino group (preferably a substituted or unsubstituted alkoxycarbonylamino group having from 2 to 30 carbon atoms, more preferably from 2 to 10 carbon atoms, for example, a methoxycarbonylamino group, an ethoxycarbonylamino group, a tert-butoxycarbonylamino group, an n-octadecyloxycarbonylamino group, an N-methyl-methoxycarbonylamino group), an aryloxycarbonylamino group (preferably a substituted or unsubstituted aryloxycarbonylamino group having from 7 to 30 carbon atoms, more preferably from 7 to 10 carbon atoms, for example, a phenoxycarbonylamino group, a p-chlorophenoxycarbonylamino group, an m-n-octyloxyphenoxycarbonylamino group), a sulfamoylamino group (preferably a substituted or unsubstituted sulfamoylamino group having from 0 to 30 carbon atoms, more preferably from 0 to 10 carbon atoms, for example, a sulfamoylamino group, an N,N-dimethylaminosulfonylamino group, an N-n-octylaminosulfonylamino group), an alkyl and arylsulfonylamino group (preferably a substituted or unsubstituted alkylsulfonylamino group having from 1 to 30 carbon atoms, more preferably from 1 to 10 carbon atoms, or a substituted or unsubstituted arylsulfonylamino group having from 6 to 30 carbon atoms, more preferably from 6 to 10 carbon atoms, for example, a methylsulfonylamino group, a butylsulfonylamino group, a phenylsulfonylamino group, a 2,3,5-trichlorophenylsulfonylamino group, a p-methylphenylsulfonylamino group), a mercapto group, an alkylthio group (preferably a substituted or unsubstituted alkylthio group having from 1 to 30 carbon atoms, more preferably from 1 to 10 carbon atoms, for example, a methylthio group, an ethylthio group, an n-hexadecylthio group), an arylthio group (preferably a substituted or unsubstituted arylthio group having from 6 to 30 carbon atoms, more preferably from 6 to 10 carbon atoms, for example, a phenylthio group, a p-chlorophenylthio group, a m-methoxyphenylthio group), a heterocyclic-thio group (preferably a substituted or unsubstituted heterocyclic-thio group having from 2 to 30 carbon atoms, more preferably from 2 to 10 carbon atoms, for example, a 2-benzothiazolylthio group, a 1-phenyltetrazol-5-ylthio group), a sulfamoyl group (preferably a substituted or unsubstituted sulfamoyl group having from 0 to 30 carbon atoms, more preferably from 0 to 10 carbon atoms, for example, an N-ethylsulfamoyl group, an N-(3-dodecyloxypropyl)sulfamoyl group, an N,N-dimethylsulfamoyl group, an N-acetylsulfamoyl group, an N-benzoylsulfamoyl group, an N—(N′-phenylcarbamoyl)sulfamoyl group), a sulfo group, an alkyl and arylsulfinyl group (preferably a substituted or unsubstituted alkylsulfinyl group having from 1 to 30 carbon atoms, more preferably from 1 to 10 carbon atoms, or a substituted or unsubstituted arylsulfinyl group having from 6 to 30 carbon atoms, more preferably from 6 to 10 carbon atoms, for example, a methylsulfinyl group, an ethylsulfinyl group, a phenylsulfonyl group, a p-methylphenylsulfinyl group), an alkyl and arylsulfonyl group (preferably a substituted or unsubstituted alkylsulfonyl group having from 1 to 30 carbon atoms, more preferably from 1 to 10 carbon atoms, or a substituted or unsubstituted arylsulfonyl group having from 6 to 30 carbon atoms, more preferably from 6 to 10 carbon atoms, for example, a methylsulfonyl group, an ethylsulfonyl group, a phenylsulfonyl group, a p-methylphenylsulfonyl group), an acyl group (preferably a formyl group, a substituted or unsubstituted alkylcarbonyl group having from 2 to 30 carbon atoms, more preferably from 2 to 10 carbon atoms, or a substituted or unsubstituted arylcarbonyl group having from 7 to 30 carbon atoms, more preferably from 7 to 10 carbon atoms, for example, an acetyl group, a pivaloyl group, a benzoyl group), an aryloxycarbonyl group (preferably a substituted or unsubstituted aryloxycarbonyl group having from 7 to 30 carbon atoms, more preferably from 7 to 10 carbon atoms, for example, a phenoxycarbonyl group, an o-chlorophenoxycarbonyl group, an m-nitrophenoxycarbonyl group, a p-tert-butylphenoxycarbonyl group), an alkoxycarbonyl group (preferably a substituted or unsubstituted alkoxycarbonyl group having from 2 to 30 carbon atoms, more preferably from 2 to 10 carbon atoms, for example, a methoxycarbonyl group, an ethoxycarbonyl group, a tert-butoxycarbonyl group, an n-octadecyloxycarbonyl group), a carbamoyl group (preferably a substituted or unsubstituted carbamoyl group having from 1 to 30 carbon atoms, more preferably from 1 to 10 carbon atoms, for example, a carbamoyl group, an N-methylcarbamoyl group, an N,N-dimethylcarbamoyl group, an N,N-di-n-octylcarbamoyl group, an N-(methylsulfonyl)carbamoyl group), an aryl and heterocyclic-azo group (preferably a substituted or unsubstituted arylazo group having from 6 to 30 carbon group, more preferably from 6 to 10 carbon atoms, or a substituted or unsubstituted heterocyclic-azo group having from 3 to 30 carbon atoms, more preferably from 3 to 10 carbon atoms, for example, a phenylazo group, a p-chlorophenylazo group, a 5-ethylthio-1,3,4-thiadiazol-2-ylazo group), an imide group (preferably an N-succinimide group, an N-phthalimide group), a phosphino group (preferably a substituted or unsubstituted phosphino group having from 2 to 30 carbon atoms, more preferably from 2 to 10 carbon atoms, for example, a dimethylphosphino group, a diphenylphosphino group, a methylphenoxyphosphino group), a phosphinyl group (preferably a substituted or unsubstituted phosphinyl group having from 2 to 30 carbon atoms, more preferably from 2 to 10 carbon atoms, for example, a phosphinyl group, a dioctyloxyphosphinyl group, a diethoxyphosphinyl group), a phosphinyloxy group (preferably a substituted or unsubstituted phosphinyloxy group having from 2 to 30 carbon atoms, more preferably from 2 to 10 carbon atoms, for example, a diphenoxyphosphinyloxy group, a dioctyloxyphosphinyloxy group), a phosphinylamino group (preferably a substituted or unsubstituted phosphinylamino group having from 2 to 30 carbon atoms, more preferably from 2 to 10 carbon atoms, for example, a dimethoxyphosphinylamino group, a dimethylaminophosphinylamino group), a silyl group (preferably a substituted or unsubstituted silyl group having from 3 to 30 carbon atoms, more preferably from 3 to 10 carbon atoms, for example, a trimethylsilyl group, a tert-butyldimethylsilyl group, a phenyldimethylsilyl group).

Of the above substituents, those having a hydrogen atom may be further substituted with any of the above-mentioned substituents by removing the hydrogen atom. Examples of the functional group are an alkylcarbonylaminosulfonyl group, an arylcarbonylaminosulfonyl group, an alkylsulfonylaminocarbonyl group, an arylsulfonylaminocarbonyl group. Concretely, they include a methylsulfonylaminocarbonyl group, a p-methylphenylsulfonylaminocarbonyl group, an acetylaminosulfonyl group, a benzoylaminosulfonyl group.

In formula (I), A⁴ may represent a substituted or non-substituted aryl group such as phenyl or naphthyl.

In formula (I), A¹-A³ each independently may represent a substituted or non-substituted alkyl group, or A¹ and A² may bind to each other to form a nitrogen-containing ring.

The alkyl group each independently represented by A¹-A³ is preferably a C₁₋₂₀ (more preferably C₁₋₁₀, or even more preferably C₁₋₅) alkyl group, and examples thereof include methyl, ethyl and propyl. The alkyl group may be linear or branched. The alkyl group may have at least one substituent binding to any site thereof. Examples of the substituent thereof include a halogen atom (for example, a fluorine atom, a chlorine atom, a bromine atom, an iodine atom), an aryl group (for example, a phenyl group, a naphthyl group), cyano, carboxyl, an alkoxycarbonyl group (for example, methoxycarbonyl), an aryloxycarbonyl group (for example, phenoxycarbonyl), a substituted or non-substituted carbamoyl group (for example, non-substituted carbamoyl, N-phenyl carbamoyl, N,N-dimethyl carbamoyl), an alkyl carbonyl group (for example, acetyl), an aryl carbonyl group (for example, benzoyl), nitro, a substituted or non-substituted amino group (for example, non-substituted amino, dimethyl amino, anilino), an acyl amino group (for example, acetoamide, ethoxycarbonyl amino), a sulfonamide group (for example, methane sulfonamide), an imido group (for example, succinimido, phthalimido), an imino group (for example, benzylidene amino), hydroxy, an alkoxy group (for example, methoxy), an aryloxy group (for example, phenoxy), an acyloxy group (for example, acetoxy), an alkylsulfonyloxy group (for example, methane sulfonyloxy), an arylsulfonyloxy group (for example, benzene sulfonyloxy), sulfo, a substituted or non-substituted sulfamoyl group (for example, non-substituted sulfamoyl, N-phenyl sulfamoyl), an alkylthio group (for example, methylthio), an arylthio group (for example, phenylthio), an alkylsulfonyl group (for example, methane sulfonyl), an arylsulfonyl group (for example, benzene sulfonyl), and a heterocyclic group (for example, pyridyl or morpholino). These substituents may have at least one substituent, and the two or, more substituents may be same or different from each other. The substituents may bind to each other to form a ring.

A¹ and A² may bind to each other to form a ring. The ring is preferably a saturated ring, more preferably a 6-membered saturated ring, or even more preferably a piperidine ring.

Preferably, A¹-A³ each independently represent a non-substituted alkyl group or an alkyl group having cyano, an alkoxycarbonyl group or phenyl, or they bind to each other to form a piperidine ring.

Preferable examples of the compound represented by formula (I) include any compounds represented by formula (I-a).

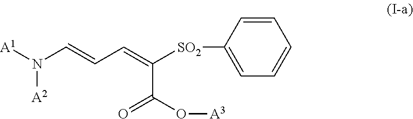

In formula (I-a), the definitions of A¹, A² and A³ are same as those in formula (I), and preferable examples are same as those of formula (I).

Examples of the merocyanine compound, having λₘₐₓ of not longer than 375 nm include, but are not limited to, those shown below.

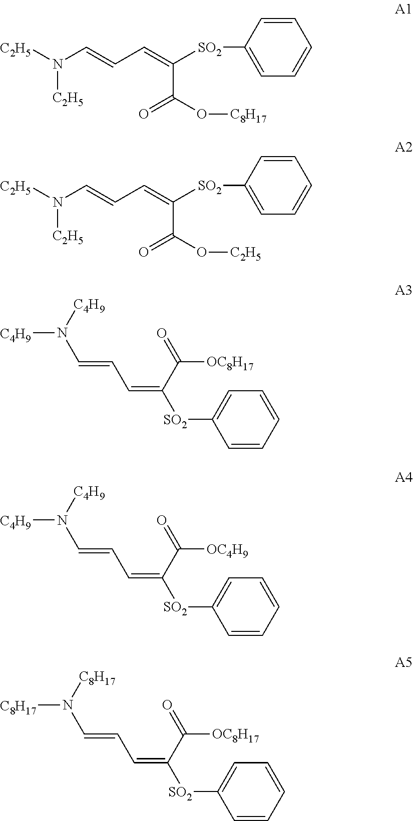

The polymer film of the invention may contain the merocyanine compound with λₘₐₓ of not longer than 375 nm singly or in combination with two or more others. A total amount of the merocyanine compound with λₘₐₓ of not longer than 375 nm is preferably from 0.2 to 10 parts by mass, more preferably from 0.2 to 7 parts by mass, or even more preferably from 0.5 to 5 parts by mass, with respect to the total of the polymer film.

If the amount is smaller than 0.2 parts by mass, it may be impossible to control the wavelength-dispersion characteristics of the polymer film; or if the amount is larger than 10 parts by mass, the light-resistance may be lowered with time.

The λₘₐₓ of the merocyanine compound with λₘₐₓ of not longer than 375 nm is equal to or shorter than 375 nm, preferably equal to or shorter than 365 nm, or equal to or shorter than 360 nm.

If the λₘₐₓ is longer than 375 nm, discoloration may occur; or if the λₘₐₓ is equal to or shorter than 350 nm, the wavelength-dispersion characteristics may be lowered. The λₘₐₓ of the merocyanine compound of which λₘₐₓ is equal to or shorter than 375 nm is preferably shorter than the λₘₐₓ of the compound represented by formula (II); and from this point of view, the λₘₐₓ of the merocyanine compound of which λₘₐₓ is equal to or shorter than 375 nm is preferably from 350 nm to 375 nm, or more preferably from 350 nm to 370 nm.

### 1-(3) Compound Represented by Formula (II)

The polymer film of the invention contains at least one merocyanine compound represented by formula (II). The compound represented by formula (II) is different from the merocyanine compound of which λₘₐₓ is equal to or shorter than 375 nm.

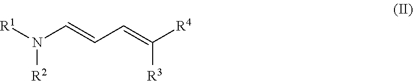

In formula (II), R¹ and R² each independently represent a hydrogen atom, alkyl group, aryl group, heterocyclic group, cyano, N-alkyl- or N-aryl carbamoyl group, aryloxy carbonyl group or —CH₂COOR⁵, or R¹ and R² bind to each other to form a ring containing a nitrogen atom, these groups and rings may have one or more substituents if possible; R⁵ represents an alkyl group, aryl group or a heterocyclic group; R³ and R⁴ each independently represent a substituent having a Hammett substituent constant σp of equal to or more than 0.2, or R³ and R⁴ bind to each other to form a cyclic active methylene compound structure, and these groups and rings may have one or more substituents if possible.

Examples of the substituent represented respectively by R¹-R⁵ are same as those of the substituent represented by A¹-A⁴ in formula (I).

R³ and R⁴ each independently represent a substituent having a Hammett substituent constant σp of equal to or more than 0.2, or R³ and R⁴ may bind to each other to form a cyclic active methylene compound structure. The Hammett substituent constant σp is described. The Hammett equation is a rule of thumb proposed by L. P. Hammett in 1935 for qualitatively discussing the influence of a substituent on the reaction or equilibrium of benzene derivatives, and now its reasonability is widely accepted in the art. The substituent constant developed by the Hammett equation includes σp and σm; and these data are found in a large number of general literature. For example, these are described in detail in J. A. Dean “Lange's Handbook of Chemistry”, Ver. 12, 1979 (McGraw-Hill); “Field of Chemistry”, extra edition, No. 122, pp. 96-103, 1979 (Nanko-do); Chem. Rev., 1991, Vol. 91, pp. 165-195, etc. The substituent having a Hammett substituent constant σp of at least 0.2 in the present invention is an electron-attractive group. σp of the substituent is preferably at least 0.25, more preferably at least 0.3, even more preferably at least 0.35.

Examples of the substituent having a Hammett substituent constant σp of at least 0.2 include a cyano group (0.66), a carboxyl group (—COON: 0.44), an alkoxycarbonyl group (—COOMe: 0.45), an aryloxycarbonyl group (—COOPh: 0.44), a carbamoyl group (—CONH₂: 0.36), an alkylcarbonyl group (—COMe: 0.50), an arylcarbonyl group (—COPh: 0.43), an alkylsulfonyl group (—SO₂Me: 0.72), or an arylsulfonyl group (—SO₂Ph: 0.68), etc. In this description, Me means a methyl group, Ph means a phenyl group. The data in the parenthesis are the σp value of the typical substituent, as extracted from Chem., Rev., 1991, Vol. 91, pp. 165-195. Examples of the substituent having a Hammett substituent constant σp of at least 0.2 include also a sulfamoyl group, a sulfinyl group and a heterocyclic group.

Among the examples, an alkyl- or aryl-carbonyl group, alkyl- or aryl-oxycarbonyl group, alkyl- or aryl-sulfonyl group, N-alkyl- or N-aryl-carbamoyl group, or cyano is preferable.

The alkyl in the alkyl-carbonyl, alky-oxycarbonyl, alkyl-sulfonyl or N-alkyl-carbamoyl group may have a linear or branched chain structure. The alkyl is preferably a C₁₋₃₀ alkyl, more preferably C₁₋₂₀ alkyl, or further more preferably C₁₋₁₅ alkyl.

The aryl in the aryl-oxycarbonyl, aryl-sulfonyl or N-aryl-carbamoyl group may be a single or condensed ring residue. The aryl is preferably phenyl.

If possible, these groups may have at least one substituent. Examples of the substituent include halogen atoms (for example, fluorine, chlorine, bromine and iodine atoms; alkyls (preferably C₁₋₁₀ alkyls, more preferably C₁₋₆ alkyls), alkoxys (preferably C₁₋₁₀ alkoxys, more preferably C₁₋₆ alkoxys), alkyloxycarbonyls (preferably C₂₋₁₁ alkyloxycarbonyls, more preferably C₂₋₆ alkyloxycarbonyls), and alkylcarbonyloxys (preferably C₂₋₁₁ alkylcarbonyloxys, more preferably C₂₋₆ alkylcarbonyloxys).

The active methylene structure formed of binding R³ and R⁴ is preferably a 5- to 7-membered ring (more preferably a 5- or 6-membered ring). The term “active methylene structure” means any structures having methylene, —CH₂—, sandwiched between two electron-withdrawing groups. Examples of the cyclic active methylene structure include those exemplified below.

(a) a 1,3-dicarbonyl nucleus, such as 1,3-indanedione nucleus, 1,3-cyclohexanedione, 5,5-dimethyl-1,3-cyclohexanedione, 1,3-dioxane-4,6-dione and Meldrum's acid;
(b) a pyrazolinone nucleus, such as 1-phenyl-2-pyrazolin-5-one, 3-methyl-1-phenyl-2-pyrazolin-5-one, and 1-(2-benzothiazoyl)-3-methyl-2-pyrazolin-5-one;
(c) an isoxazolinone nucleus, such as 3-phenyl-2-isoxazolin-5-one, and 3-methyl-2-isoxazolin-5-one;
(d) an oxyindole nucleus, such as 1-alkyl-2,3-dihydro-2-oxyindole,
(e) a 2,4,6-triketohexahydropyrimidine nucleus, such as barbituric acid, 2-thiobarbituric acid and a derivative thereof; examples of the derivative include a 1-alkyl form such as 1-methyl and 1-ethyl, a 1,3-dialkyl form such as 1,3-dimethyl, 1,3-diethyl and 1,3-dibutyl, a 1,3-diaryl form such as 1,3-diphenyl, 1,3-di(p-chlorophenyl) and 1,3-di(p-ethoxycarbonylphenyl), a 1-alkyl-1-aryl form such as 1-ethyl-3-phenyl, and a 1,3-diheterocyclic substitution form such as 1,3-di(2-pyridyl);
(f) a 2-thio-2,4-thiazolidinedione nucleus, such as rhodanine and a derivative thereof; examples of the derivative include a 3-alkylrhodanine such as 3-methylrhodanine, 3-ethylrhodanine and 3-allylrhodanine, a 3-arylrhodanine such as 3-phenylrhodanine, and a 3-heterocyclic ring-substituted rhodanine such as 3-(2-pyridyl)rhodanine;
(g) a 2-thio-2,4-oxazolidinedione (2-thio-2,4-(3H,5H)-oxazoledione) nucleus, such as 3-ethyl-2-thio-2,4-oxazolidinedione;
(h) a thianaphthenone nucleus, such as 3(2H)-thianaphthenone-1,1-dioxide;
(i) a 2-thio-2,5-thiazolidinedione nucleus, such as 3-ethyl-2-thio-2,5-thiazolidinedione;
(j) a 2,4-thiazolidinedione nucleus, such as 2,4-thiazolidinedione, 3-ethyl-2,4-thiazolidinedione and 3-phenyl-2,4-thiazolidinedione;
(k) a thiazolin-4-one nucleus, such as 4-thiazolinone and 2-ethyl-4-thiazolinone;
(l) a 4-thiazolidinone nucleus, such as 2-ethylmercapto-5-thiazolin-4-one and 2-alkylphenylamino-5-thiazolin-4-one;
(m) a 2,4-imidazolidinedione (hydantoin) nucleus, such as 2,4-imidazolidinedione and 3-ethyl-2,4-imidazolidinedione;
(n) a 2-thio-2,4-imidazolidinedione (2-thiohydantoin) nucleus, such as 2-thio-2,4-imidazolidinedione and 3-ethyl-2-thio-2,4-imidazolidinedione;
(o) an imidazolin-5-one nucleus, such as 2-propylmercapto-2-imidazolin-5-one;
(p) a 3,5-pyrazolidinedione nucleus, such as 1,2-diphenyl-3,5-pyrazolidinedione and 1,2-dimethyl-3,5-pyrazolidinedione;
(q) a benzothiophen-3-one nucleus, such as benzothiophen-3-one, oxobenzothiophen-3-one and dioxobenzothiophen-3-one; and
(r) an indanone nucleus, such as 1-indanone, 3-phenyl-1-indanone, 3-methyl-1-indanone, 3,3-diphenyl-1-indanone and 3,3-dimethyl-1-indanone.

Preferable examples of the cyclic active methylene structure include a 1,3-dicarbonyl nucleus, pyrazolinone nucleus, 2,4,6-triketohexahydropyrimidine nucleus (including thioketone bodies), 2-thio-2,4-thiazolidinedione nucleus, a 2-thio-2,4-oxazolidinedione, 2-thio-2,5-thiazolidinedione nucleus, 2,4-thiazolidinedione nucleus, 2,4-imidazolidinedione nucleus, 2-thio-2,4-imidazolidinedione nucleus, 2-imidazolin-5-one nucleus, 3,5-pyrazolidinedione nucleus, benzothiophen-3-one nucleus, and indanone nucleus; and more preferable examples of the cyclic active methylene structure include a 1,3-dicarbonyl nucleus, 2,4,6-triketohexahydropyrimidine nucleus (including thioketone bodies), and 3,5-pyrazolidinedione nucleus.

Further more preferably, the cyclic active methylene structure is selected from Active Methylene Group (I).

### Active Methylene Group (I):

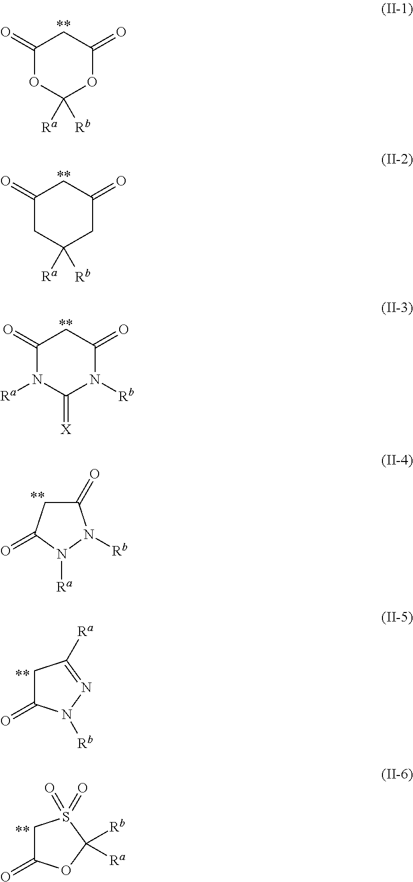

In formulas, “*” indicates a portion linking to formula (II); R^{a} and R^{b} each independently represent a hydrogen atom or an alkyl or phenyl group which may have at least one substituent, or bind each other to form a ring; and X represents an oxygen or sulfur atom.

The alkyl, which may have at least one substituent, represented by R^{a} or R^{b} is preferably a C₁₋₁₀ alkyl or more preferably C₁₋₅ alkyl such as methyl. The alkyl or phenyl represented by R^{a} or R^{b} may have at least one substituent. Examples of the substituent include halogen atoms (for example, fluorine, chlorine, bromine and iodine atoms), alkyloxycarbonyls (preferably C₂₋₁₁ alkyloxycarbonyls, more preferably C₂₋₆ alkyloxycarbonyls), and alkoxys (preferably C₁₋₁₀ alkoxys, more preferably C₁₋₅ alkoxys).

Among the above-described Active Methylene Group (I), Active Methylene Group (II) shown below is more preferable.

### Active Methylene Group (II)

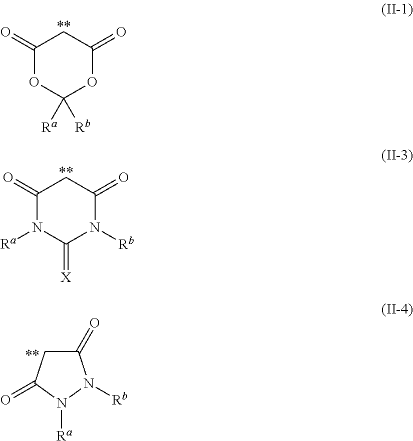

The following structure

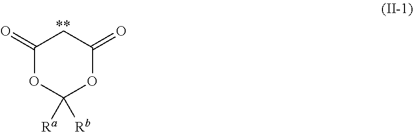

is especially preferable.

In the formulas, R^{a} and R^{b} may bind each other to form a ring. Examples of the ring include cyclohexane.

The alkyl or phenyl represented by R^{a} or R^{b} or the ring formed by binding R^{a} and R^{b} may have at least one substituent. Examples of the substituent include halogen atoms (for example, fluorine, chlorine, bromine and iodine atoms), alkyloxycarbonyls (preferably C₂₋₁₁ alkyloxycarbonyls, more preferably C₂₋₆ alkyloxycarbonyls), and alkoxys (preferably C₁₋₁₀ alkoxys, more preferably C₁₋₅ alkoxys).

Among the compound represented by formula (II), the merocyanine compound represents by formula (II′) is preferable.

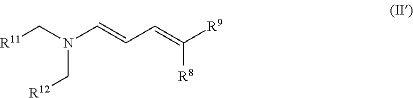

In formula (II′), R¹¹ and R¹² each independently represent a hydrogen atom, an alkyl group, an aryl group, a heterocyclic group, cyano, N-alkyl or N-aryl carbamoyl group, or —COOR¹³, or they bind to each other to form a nitrogen atom-containing ring; the definition of R¹³ is same as that of R⁵ in formula (II); R⁸ and R⁹ each independently represent cyano, —COOR¹⁴, or —SO₂R¹⁵, or they bind to each other to form a cyclic active methylene structure selected from Active Methylene Group (I); R¹³, R¹⁴ and R¹⁵ each independently represent an alkyl group, aryl group, or a heterocyclic group.

The alkyl group represented by R¹¹ or R¹² may be a non-substituted or substituted alkyl group. Examples of the substituent thereof are same as those represented by R¹ or R². The alkyl group represented by R¹¹ or R¹² is preferably a C₁₋₂₀ alkyl group, more preferably C₁₋₁₅ alkyl group, or even more preferably C₁₋₆ alkyl group.

The aryl group represented by R¹¹ or R¹² may be a non-substituted or substituted aryl group. Examples of the substituent thereof are same as those represented by R¹ or R². The aryl group represented by R¹¹ or R¹² is preferably a substituted or non-substituted phenyl group, or more preferably a non-substituted phenyl group.

R¹³ of —COOR¹³ represented by R¹¹ or R¹² is preferably a substituted or non-substituted alkyl group, or more preferably a non-substituted alkyl group. The alkyl group represented by R¹³ is preferably a C₁₋₂₀ alkyl group, more preferably C₁₋₁₅ alkyl group, or even more preferably C₁₋₆ alkyl group.

The ring which is formed by combining R¹¹ and R¹² is preferably a saturated ring, more preferably a 6-membered saturated ring, or even more preferably a piperidine ring.

Preferably, both of R¹¹ and R¹² represent cyano or non-substituted phenyl, or bind to each other to form a piperidine ring; or more preferably, both of R¹¹ and R¹² represent cyano or non-substituted phenyl.

R¹⁴ of —COOR¹⁴ represented by R⁹ or R⁹ is preferably a substituted or non-substituted alkyl group, or more preferably a non-substituted alkyl group. The alkyl group represented by R¹⁴ is preferably a C₁₋₂₀ alkyl group, or more preferably C₅₋₁₅ alkyl group.

R¹⁵ of —SO₂R¹⁵ represented by R⁸ or R⁹ is preferably an aryl group, or more preferably phenyl group.

In formula (II′), R⁸ or R⁹ may have a residue of the merocyanine compound such as the merocyanine compound represented by formula (II′) as a substituent if possible. Examples of the compound represented by formula (II′) include also the compound represented by the following formula. In the following formula, R⁹′ represents a residue which is formed by removing a hydrogen atom from R⁹ in formula (II′).

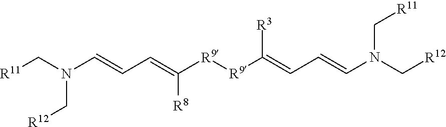

In the formula, examples of —R⁹′-R⁹′— include the divalent groups shown below. In the formulas, “**” indicates the binding site.

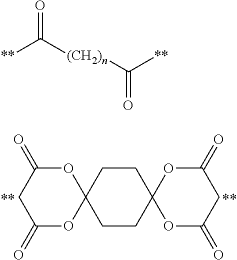

In the formula, R¹¹ and R¹² each independently represent a hydrogen atom, an aryl group, a heterocyclic group, cyano, N-alkyl or N-aryl carbamoyl group, or alkyl- or aryl-oxycarbonyl group, or they bind to each other to form a saturated ring in which carbon and nitrogen atoms are embedded.

The aryl represented by R¹¹ or R¹² may be a single-ring or condensed-ring. Phenyl is preferable.

The heterocyclic group represented by R¹¹ or R¹² may be a single-ring or condensed-ring. The heterocyclic group may be aromatic or non-aromatic. One or more hetero atoms which are embedded in the hetero ring are not limited, and examples thereof include a nitrogen atom, an oxygen atom and a sulfur atom. The 5-, 6- or 7-membered heterocyclic group is preferable, or the 5- or 6-membered heterocyclic group is more preferable.

The alkyl group in N-alkyl-carbamoyl or alkyloxycarbonyl represented by R¹¹ or R¹² is preferably a C₁₋₁₀ alkyl group, or more preferably C₁₋₆ alkyl group. Examples of the alkyl group include methyl, ethyl, propyl and butyl, and ethyl is especially preferable.

The aryl group in N-aryl-carbamoyl or aryloxycarbonyl represented by R¹¹ or R¹² may be a residue of a single-ring or condensed ring group. Phenyl is preferable.

The saturated ring, formed by combining R¹¹ and R¹², in which nitrogen and carbon atoms are embedded is preferably a 5-, 6- or 7-membered ring, or more preferably 5- or 6-membered ring. Examples of the saturated ring include a piperidine ring, piperazine ring and pyrrolidine(tetrahydro pyrrole) ring; a piperidine ring or pyrrolidine ring is preferable, and a piperidine ring is more preferable.

The substituent represented by R¹¹ or R¹² or the ring formed by combining R¹¹ and R¹² may have at least one substituent. Examples of the substituent include an alkyl group (preferably a C₁₋₁₀, or more preferably C₁₋₆ alkyl group), a halogen atom (such as a fluorine atom, chlorine atom, bromine atom and iodine atom), an alkyloxycarbonyl group (preferably C₂₋₁₁ or more preferably C₂₋₆ alkyloxtcarbonyl group), and an alkoxy group (preferably C₁₋₁₀, or more preferably C₁₋₆ alkoxy group).

In formula (II′), R¹¹ or R¹² may have a residue of the merocyanine compound such as the merocyanine compound represented by formula (II′) as a substituent if possible. Examples of the compound represented by formula (II′) include also the compound represented by the following formula. In the following formula, R¹¹′ represents a divalent residue which is formed by removing a hydrogen atom from R¹¹ in formula (II′).

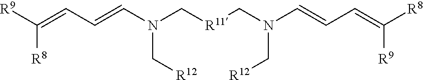

Examples of R¹¹′ include phenylene, and the divalent groups shown below where, in the formula, Ak is a C₂₋₁₀ alkyl group or alkylene oxy group).

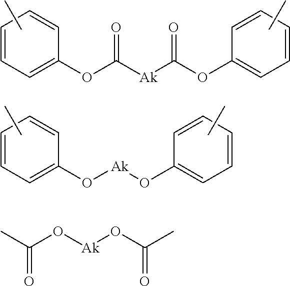

Preferably, R¹¹ and R¹² represent a same group selected from those described above, or they bind to each other to form the ring.

Preferable examples of the compound represented by formula (II) include those represented by formula (II-a), (II-b), (II-c), or (II-d).

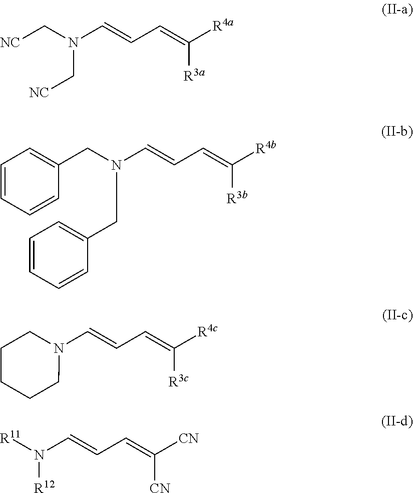

In formulas (II-a), (II-b) and (1′-c), the definitions of R^{3a}, R^{3b} and R³ are same as that of R³ in formula (II); the definitions of R^{4a}, R^{4b} and R^{4c} are same as that of R⁴ in formula (II); and the definitions of R¹¹ and R¹² in formula (II-d) are same as those of R¹ and R² in formula (II).

In formula (II-a), R^{3a} and R^{4a} have the same meanings as R³ and R⁴ in formula (II), respectively, and their preferred ranges are also the same as those R³ and R⁴. Above all, compounds having any of the cyclic active methylene structures (II-1) to (II-6) are preferred from the viewpoint of the ability thereof to prevent discoloration and to secure light-resistance.

In formula (II-b), R^{3b} and R^{3b} have the same meanings as R³ and R⁴ in formula (II), respectively, and their preferred ranges are also the same as those of R³ and R⁴. Above all, compounds having a cyano group as both of R^{3b} and R^{3b} or compounds having any of the cyclic active methylene structures (II-1) to (II-6) (more preferably, (II-1) or (II-4), even more preferably (1′-1)) formed by combining f R^{3b} and R^{3b} are preferred from the viewpoint of the ability thereof to prevent discoloration and to secure light-resistance. Especially preferred are the compounds where the two substituents are both a cyano group.

In formula (II-c), R^{3c} and R^{3c} have the same meanings as R³ and R⁴, respectively, and their preferred ranges are also the same as those of the R³ and R⁴. Above all, compounds in which one of the substituents is a cyano group and the other is —COOR¹⁴ (the definition and the preferred range of R¹⁴ are the same as above), or the substituents form any of the cyclic active methylene structures (II-1) to (II-6) are preferred.

In formula (II-d), R¹¹ and R¹² have the same meanings as those in formula (II′), and their preferred ranges are also the same as those of R¹¹ and R¹².

The compound represented by formula (II) exhibits a function of improving the light-resistance of the merocyanine compound with λₘₐₓ of not longer than 375 nm by being mixed with the merocyanine compound with λₘₐₓ of not longer than 375 nm. Among the compounds, the compound represented by any one of formulas (II-a), (II-b), (II-c) and (II-d) exhibits a function of more improving the light-resistance of the merocyanine compound with λₘₐₓ of not longer than 375 nm.

Examples of the compound represented by formula (II) include, but are not limited, those shown below.

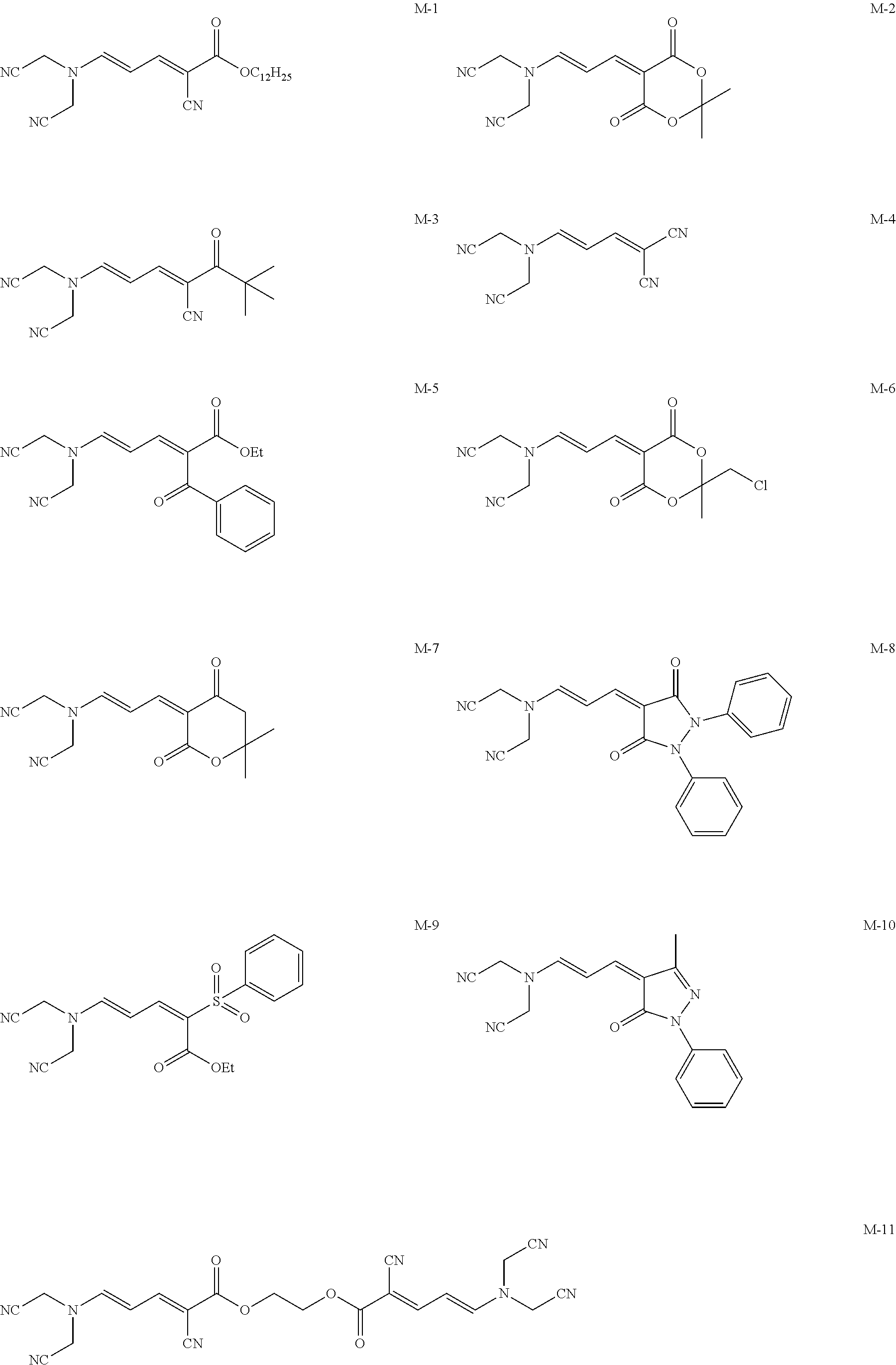

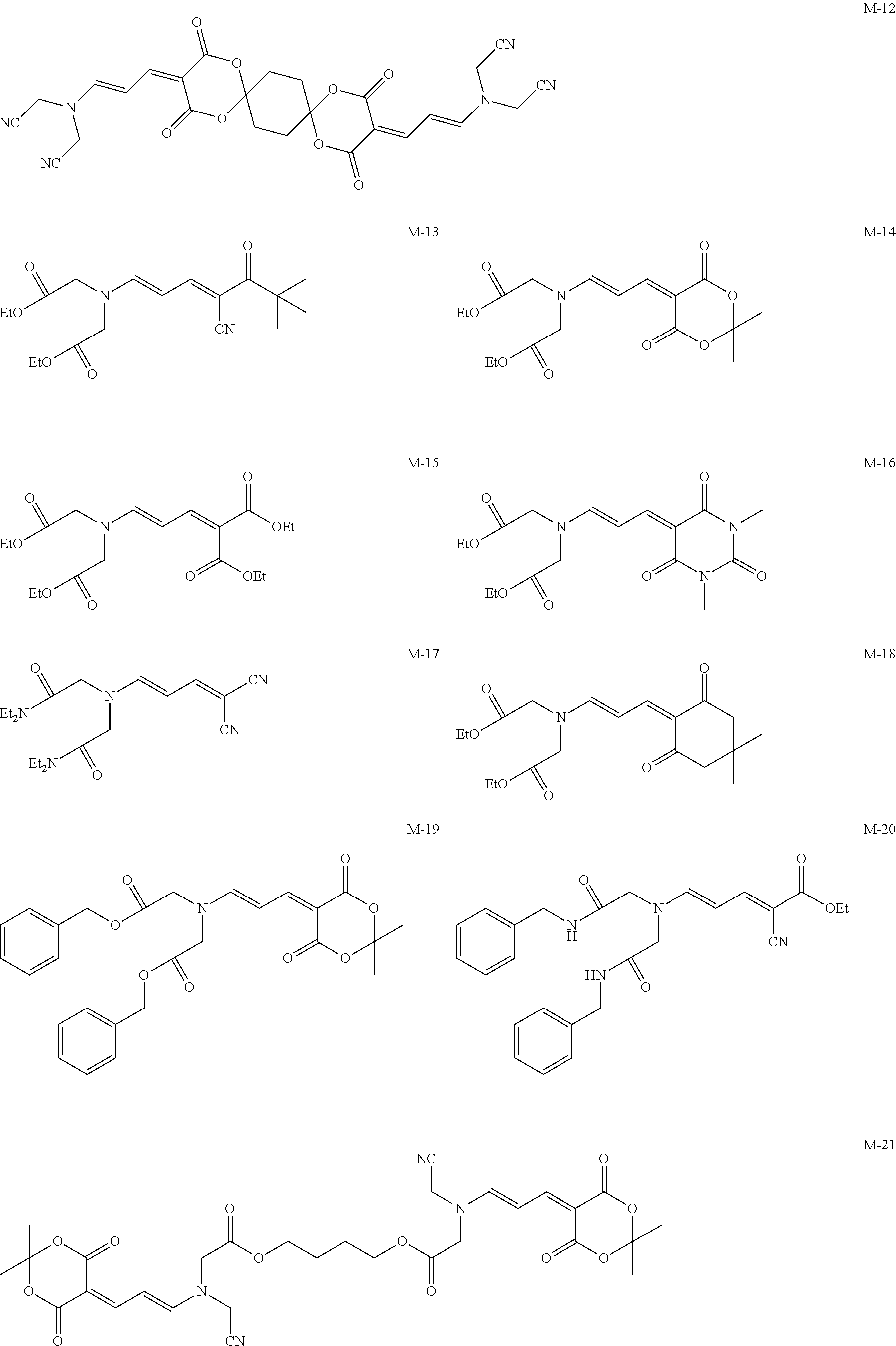

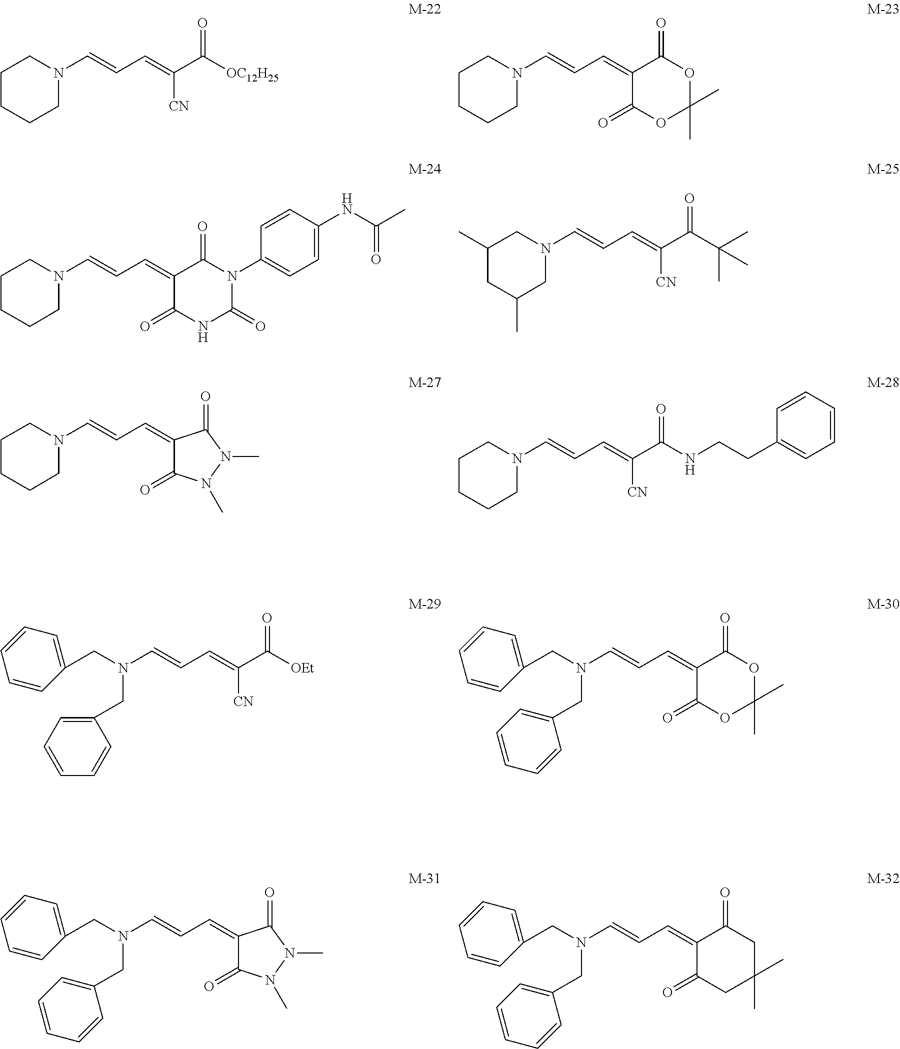

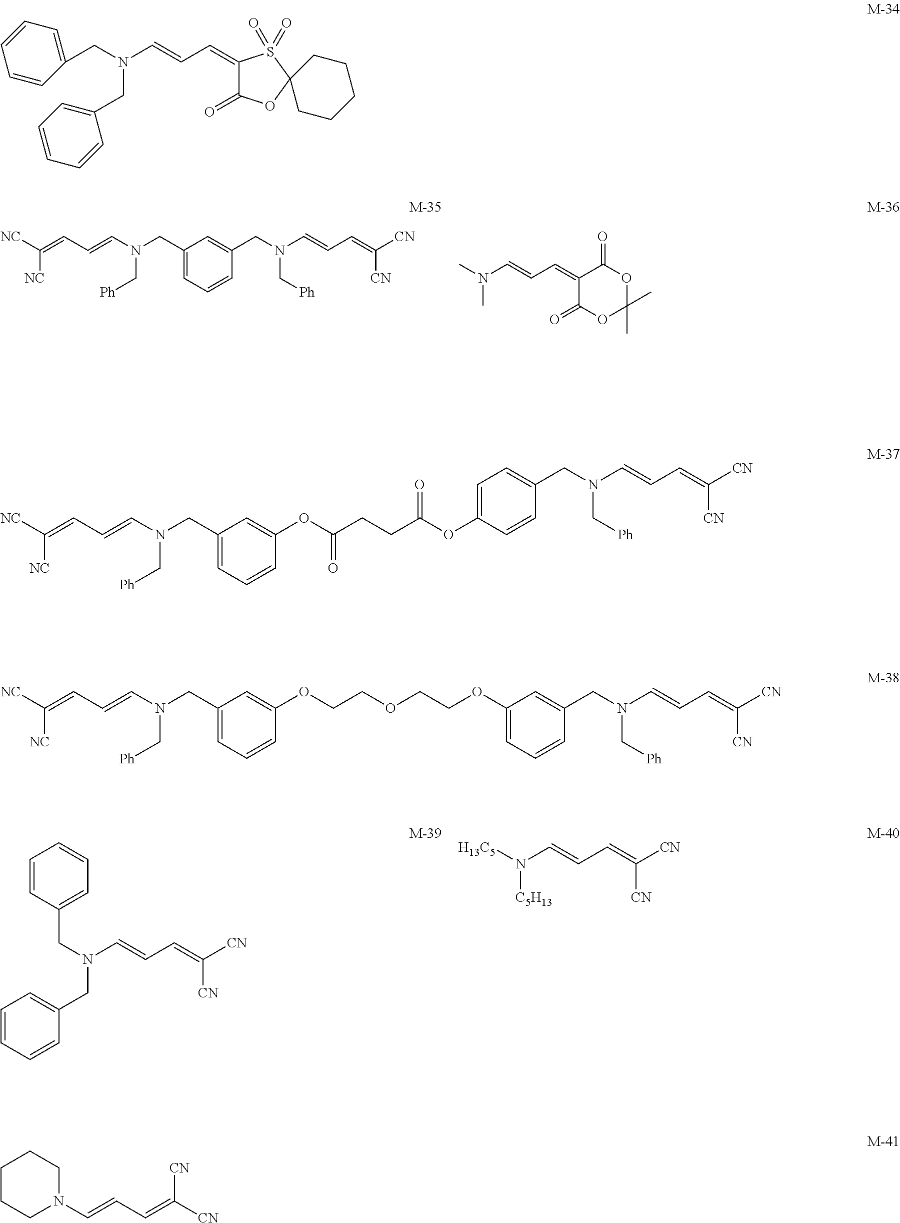

The polymer film of the present invention may contain a compound represented by formula (II) alone, or two or more compounds represented by formula (II). A total amount of the compound represented by formula (II) is preferably from 0.2 to 10 parts by mass, more preferably from 0.2 to 7 parts by mass, or even more preferably from 0.5 to 5 parts by mass with respect to the polymer film as a whole.

If the amount is smaller than 0.2 parts by mass, it may be impossible to improve the light-resistance of the merocyanine compound with λₘₐₓ of not longer than 375 nm; or if the amount is larger than 10 parts by mass, it may be impossible to prevent discoloration of the polymer film.

The preferable range of the mixed ratio by mass of the merocyanine compound with λₘₐₓ of not longer than 375 nm and the compound represented by formula (II) is as follows:

[Compound represented by formula (II)]/[Compound with λₘₐₓ of not longer than 375 nm] is preferably from 5/1 to 2/5, more preferably from 4/1 to 2/4, or even more preferably from 3/2 to 2/3.

If the mixed ratio is smaller than 5/1, it may be impossible to prevent discoloration of the polymer film; or if the mixed ratio is larger than 2/5, the light-resistance may be lowered with time.

The λₘₐₓ of the compound represented by formula (II) is preferably longer than 350 nm, more preferably longer than 365 nm, or even more preferably longer than 375 nm. If the λₘₐₓ is equal to or shorter than 375 nm, the wavelength-dispersion characteristics may be worsened.

For obtaining the effect of improving the light-resistance, the λₘₐₓ of the compound represented by formula (II) is preferably longer than the λₘₐₓ of the compound with λₘₐₓ of not longer than 375 nm; and from this viewpoint, the λₘₐₓ of the compound represented by formula (II) is preferably from 370 nm to 390 nm, or more preferably from 375 nm to 400 nm. If the λₘₐₓ is longer than 400 nm, coloration may be worsened. The term “λₘₐₓ” means a wavelength of absorption peak of the merocyanine compound.

As described above, the compound represented by formula (II) exhibits a function of preventing the decomposition of the merocyanine compound with λₘₐₓ of not longer than 375 nm by being mixed with the merocyanine compound with λₘₐₓ of not longer than 375 nm. For this reason, the residual amounts of the merocyanine compound having λₘₐₓ of not longer than 375 nm and the compound represented by formula (II) are preferably equal to or more than 80%, more preferably equal to or more than 90%, or even more preferably equal to or more than 95%, respectively after being subjected to an irradiation of light with an irradiance of 150 W/m² for 200 hours.

The compound represented by formula (II) may be produced according to any process without any limitation. For example, the compound may be produced according to a process shown below as Scheme 1. The compound may be produced by reacting a streptocyanine represented by formula (III) and a compound having nitryl represented by formula (IV) in an organic solvent. In the process, a base may be used or not.

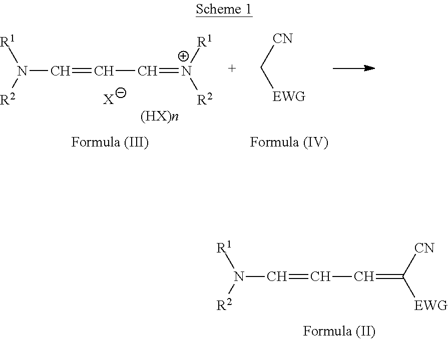

In Scheme 1, R¹ and R² each independently represent a substituted or non-substituted alkyl group, or R¹ and R² may bind to each other to form a ring; X represents an acid radical; EWG represents cyano or amide (—CO—NH—R³); R³ represents an alkyl group or an aryl group, which may have at least one substituent; and n is an integer of from 1 to 5.

R¹ and R² each independently represent a substituted or non-substituted alkyl group; and a C₁₋₁₂ alkyl group is preferable. Examples of the substitution include an aryl group, a halogen atom, a methoxy group and an ether group.

As the acid radical represented by X, acetic acid radical, chloric acid radical, formic acid radical, bromide, iodide, perchloric acid radical, p-toluene sulfonic acid radical, and methane sulfonic acid radical are exemplified; and hydrochloric acid radical, acetic acid radical and formic acid radical are preferable.

The compounds represented by formula (III) and (IV) may be commercially available or produced according to any known process.

Examples of the organic solvent include aromatic solvents such as toluene and benzene; hydro carbon solvents such as hexane and petroleum ether; ester solvents such as ethyl acetate and methyl acetate; alcohol solvents such as methanol, ethanol, isopropanol, butanol, t-butanol, and ethylene glycol; amide solvents such as dimethyl formamide, dimethyl acetamide, diethyl acetamide, diethyl propionamide and 1-methylpyrrolidone; ether solvents such as diethyl ether, dioxane and tetrahydrofuran; and polar solvents such as dimethyl sulf oxide.

The reaction temperature is preferably from −78 degrees Celsius to the boiling point of the solvent to be used, or more preferably from 0 to 70 degrees Celsius.

The method for preparing the polymer film of the invention is not limited. And any known methods such as a solution film-forming method and a melt film-forming method may be used.

The polymer film of the invention may contain other ultraviolet absorber(s) along with the merocyanine compound having λₘₐₓ of not longer than 375 nm and the compound represented by formula (II). The polymer film of the invention may contain other additive(s) such as a plasticizer, anti-degradation agent (for example, antioxidant, peroxide decomposer, radical-inhibitor, metal deactivator, oxygen-trapping agent, or amine), and organic and/or inorganic fine particles.

For accelerating the volatilization rate of the solvent and reducing the amount of the residual solvent, an aryl-containing oligomer may be used as a plasticizer. By embedding an aryl group in an oligomer regularly, it is possible to increase the alignment degree of the oligomer molecule effectively after a heat treatment. The aryl-containing oligomer is preferably selected from polycondensation esters containing at least one dicarboxylic acid residue and at least one diol residue. The aryl group may be contained in either the dicarboxylic acid residue or the diol residue; and among these, the polycondensation esters having an aryl in the dicarboxylic acid residue are preferable. More specifically, the aryl-containing oligomer is preferably selected from polycondensation esters containing at least one aromatic dicarboxylic acid residue and at least one aliphatic diol residue.

The merocyanine compound having λₘₐₓ of not longer than 375 nm and the compound represented by formula (II) have no absorption in the visible light region, and it is possible to prepare the polymer film of the invention as a transparent polymer film by selecting the polymer to be used along with the compounds. The polymer film has an ultraviolet absorbing ability by containing the merocyanine compound having λₘₐₓ of not longer than 375 nm and the compound represented by formula (II), and is useful in various usages such as protective films for various members, anti-insect films, films for solar cell modules and films for architectural materials.

### 2. Retardation Film

The present invention relates also to the retardation film comprising a polymer of the invention and an optically anisotropic layer of a cured liquid crystal composition. The retardation film may have two or more optically anisotropic layers of a cured liquid crystal composition. The retardation film is useful for optical compensation of liquid crystal display devices employing any mode such as a TN mode.

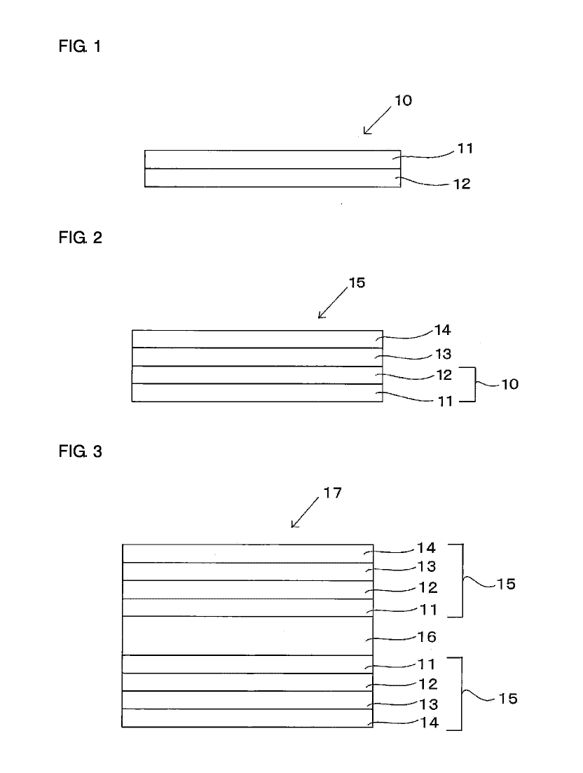

FIG. 1 shows a schematic cross-sectional view of one embodiment of the retardation film of the invention. The retardation film 10 in FIG. 1 comprises an optically anisotropic layer 11 formed of a liquid-crystal composition, and a polymer film 12 of the invention to support the layer 11. Between the optically anisotropic layer 11 and the polymer film 12, an alignment film for controlling the alignment of liquid-crystal molecules may be arranged in forming the optically anisotropic layer 11 formed of a liquid-crystal composition. FIG. 1 is a schematic view, and therefore the relative thickness of the constitutive layers does not always reflect the relative thickness of the layers in an actual optical compensatory film. The same shall apply to FIG. 2 and FIG. 3 to be given below.

### 2-(1) Support (Polymer Film of the Invention):

In the retardation film of the invention, the polymer film of the invention is used as the support for the optically anisotropic layer to be described below. In an embodiment where the retardation film is used for optical compensation in TN-mode liquid-crystal display devices, preferred is use of a polymer film of which Re is from 60 to 100 nm and Rth is from 40 to 80 nm.

### 2-(2) Optically Anisotropic Layers:

The retardation film of the invention has at least one optically anisotropic layer formed of a liquid-crystal composition. Optionally, the film may have two or more such layers. In an embodiment where the retardation film is used for optical compensation in TN-mode liquid-crystal display devices, preferably, the optically anisotropic layer has the characteristics that its Re(550) is from 20 to 100 nm, it has no direction in which its Re(550) is 0 nm, and the direction in which the absolute value of its Re(550) is the smallest is neither in the normal direction of the layer nor the in-plane direction. One example of the optically anisotropic layer having such characteristics is an optically anisotropic layer formed by fixing a liquid-crystal composition in a hybrid alignment state. Especially preferred is an optically anisotropic layer formed by fixing a liquid-crystal composition containing a discotic compound in a hybrid alignment state. More preferably, Re(550) of the optically anisotropic layer is from 20 to 40 nm.

The liquid-crystal composition for use in forming the optically anisotropic layer is preferably a liquid-crystal composition capable of forming a nematic phase and a smectic phase. Liquid-crystal compounds are generally divided into rod-shaped liquid-crystal compounds and discotic liquid-crystal compounds based on the shape of their molecules; and in the invention, liquid-crystal compounds of any form are employable.

### Discotic Liquid-Crystal Compound:

As the discotic liquid-crystal compound for use in forming the optically anisotropic layer, preferred are the compounds of the general formula (D1) described in detail in JP-A 2006-76992, paragraph [0012] and later. Concretely, preferred for use in the invention are the compounds described in JP-A 2006-76992, paragraph [0052], and in JP-A 2007-2220, paragraphs [0040] to [0063]. These compounds are preferred as exhibiting high birefringence. Of the compounds of the formula (DI), those exhibiting discotic liquid-crystallinity are preferred, and those exhibiting discotic-nematic phase are more preferred.

Preferred examples of the discotic compounds include those described in JP-A 2005-301206.

### Rod-Shaped Liquid-Crystal Compound:

Rod-shaped liquid-crystal compounds are usable as the material for the optically anisotropic layer.

Use of least two different types of rod-shaped liquid-crystal compounds is preferred for satisfying the necessary properties of the optically anisotropic layer. One preferred combination is a combination of at least one rod-shaped liquid-crystal compound of the following general formula (X) and at least one rod-shaped liquid-crystal compound of the following general formula (XI):

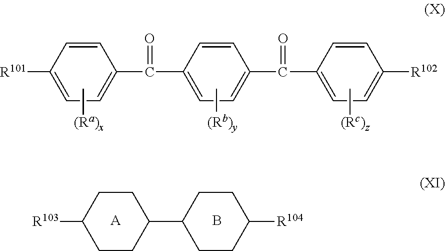

In the formulae, A and B each represent a group of an aromatic or aliphatic hydrocarbon ring or a hetero ring; R¹⁰¹ to R¹⁰⁴ each represent a substituted or unsubstituted, C₁₋₁₂ (preferably C₃₋₇) alkylene chain-containing alkoxy, acyloxy, alkoxycarbonyl or alkoxycarbonyloxy group; R^{a}, R^{b} and A^{rc} each represent a substituent; x, y and z each indicate an integer of from 1 to 4.

In the formulae, the alkylene chain contained in R¹⁰¹ to R¹⁰⁴ may be linear or branched. Preferably, the chain is linear. For curing the composition, preferably, R¹⁰¹ to R¹⁰⁴ have a polymerizing group at the terminal thereof. Examples of the polymerizing group include an acryloyl group, a methacryloyl group, an epoxy group, etc.

In the formula (X), preferably, x and z are 0 and y is 1. Preferably, one R^{b} is a meta- or ortho-positioned substituent relative to the oxycarbonyl group or the acyloxy group. Preferably, R^{b} is a C₁₋₁₂ alkyl group (e.g., methyl group), a halogen atom (e.g., fluorine atom), etc.

In the formula (XI), preferably, A and B each are a phenylene group or a cyclohexylene group. Preferably, both of A and B are phenylene groups, or one of them is a cyclohexylene group and the other is a phenylene group.

### Method for Formation of Optically Anisotropic Layer:

Preferably, the optically anisotropic layer is formed by applying a composition containing at least one liquid-crystal compound to the surface of the polymer film of the invention or to the surface of an alignment film formed on the polymer film, then aligning the liquid-crystal compound molecules in a desired alignment state, and curing the composition through polymerization to thereby fix the alignment state. In order that the optically anisotropic layer satisfies the characteristics that it does not have a direction in which its Re(550) is 0 nm and the direction in which the absolute value of its Re(550) is the smallest is neither in the normal direction of the layer nor in the in-plane direction, preferably, the liquid-crystal compound molecules (including both rod-shaped and discotic molecules) are fixed in a hybrid alignment state. Hybrid alignment means that the direction of the director of the liquid-crystal molecules continuously changes in the thickness direction of the layer. For rod-shaped molecules, the director is the long axis direction; and for discotic molecules, the director is the normal line direction to the discotic face.

In order to make the liquid-crystal compounds aligned in a desired alignment state, and for the purpose of bettering the coatability and the curability of the composition, the composition may contain at least one additive.

For hybrid alignment of the molecules of liquid-crystal compound (especially rod-shaped liquid-crystal compound), an additive capable of controlling the alignment on the air interface side of the layer may be added to the composition (hereinafter the additive is referred to as “air-interface alignment controlling agent”). The additive includes low-molecular or high-molecular compounds having a hydrophilic group such as a fluoroalkyl group, a sulfonyl group, etc. Specific examples of the air-interface alignment controlling agent usable here include the compounds described in JP-A 2006-267171.

In case where a coating liquid of the composition is prepared and the optically anisotropic layer is formed in a mode of coating with the liquid, a surfactant may be added to the liquid for bettering the coatability. The surfactant is preferably a fluorine-containing compound, including, for example, the compounds described in JP-A 2001-330725, paragraphs [0028] to [0056]. A commercial product, “Megafac F780” (by Dai-Nippon Ink) is also usable.

And the composition preferably contains at least one polymerization initiator. The polymerization initiator may be selected from thermal or photo-polymerization initiators. In terms of ease of controlling, photo-polymerization initiators are preferable. Examples of the photo-polymerization initiator, which is capable of generating radicals under irradiation with light, include alpha-carbonyl compounds (described in U.S. Pat. Nos. 2,367,661 and 2,367,670), acyloin ether (described in U.S. Pat. No. 2,448,828), alpha-hydrocarbon-substituted aromatic acyloin compounds (described in U.S. Pat. No. 2,722,512), polynuclearquinone compounds (described in U.S. Pat. Nos. 3,046,127 and 2,951,758), combinations of triarylimidazole dimers and p-aminophenyl ketones (described in U.S. Pat. No. 3,549,367), acridine and phenadine compounds (described in JPA No. sho 60-105667 and U.S. Pat. No. 4,239,850), oxadiazole compounds (described in U.S. Pat. No. 4,212,970), acetophenone type compounds, benzoin ether type compounds, benzyl type compounds, benzophenone type compounds, and thioxanthone type compounds. Examples of the acetophenone compound include, for example, 2,2-diethoxyacetophenone, 2-hydroxymethyl-1-phenylpropan-1-one, 4′-isopropyl-2-hydroxy-2-methyl-propiophenone, 2-hydroxy-2-methyl-propiophenone, p-dimethylaminoacetone, p-tert-butyldichloroacetophenone, p-tert-butyltrichloroacetopheone, p-azidobenzalacetophenone. Examples of the benzyl compound include, for example, benzyl, benzyl dimethyl ketal, benzyl 8-methoxyethyl acetal, 1-hydroxycyclohexyl phenyl ketone. The benzoin ether compounds include, for example, benzoin, benzoin methyl ether, benzoin ethyl ether, benzoin n-propyl ether, benzoin isopropyl ether, benzoin n-butyl ether, and benzoin isobutyl ether. Examples of the benzophenone compound include benzophenone, methyl o-benzoylbenzoate, Michler's ketone, 4,4′-bisdiethylaminobenzophenone, 4,4′-dichlorobenzophenone. Examples of the thioxanthone compound include thioxanthone, 2-methylthioxanthone, 2-ethylthioxanthone, 2-isopropylthioxanthone, 4-isopropylthioxanthone, 2-chlorothioxanthone, and 2,4-diethylthioxanthone. Of those aromatic ketones serving as a light-sensitive radical polymerization initiator, more preferred are acetophenone compounds and benzyl compounds in point of their curing capability, storage stability and odorlessness. One or more such aromatic ketones may be used herein as a light-sensitive radical polymerization initiator, either singly or as combined depending on the desired performance of the initiator.

For the purpose of increasing the sensitivity thereof, a sensitizer may be added to the polymerization initiator. Examples of the sensitizer are n-butylamine, triethylamine, tri-n-butyl phosphine, and thioxanthone.

Plural types of the photopolymerization initiators may be combined and used herein, and the amount thereof is preferably from 0.01 to 20% by mass around of the solid content of the coating liquid, more preferably from 0.5 to 5% by mass around. For light irradiation for polymerization of the liquid-crystal compound, preferably used are UV rays.

The composition may comprise a polymerizable non-liquid crystal monomer(s) along with the polymerizable liquid crystal compound. Examples of the polymerizable monomer include compounds having a vinyl, vinyloxy, acryloyl or methacryloyl. For improving the durability, polyfunctional monomers, having two or more polymerizable groups, such as ethyleneoxide-modified trimethylolpropane acrylates may be used.

The amount of the polymerizable non-liquid crystal monomer is preferably equal to or less than 15% by mass around and more preferably from 0 to 10% by mass around with respect to the amount of the liquid crystal compound.

The optically anisotropic layer may be prepared as follows. The composition is prepared as a coating liquid, and applied to a surface of an alignment layer disposed on the polymer film of the invention. After that, the composition is dried to remove solvent therefrom, thereby align liquid crystal molecules. Then, the alignment is fixed via polymerization, and an optically anisotropic layer is prepared. Examples of the alignment layer which can be used in the invention include polyvinyl alcohol films and polyimide films.

The coating method may be any known method of curtain-coating, dipping, spin-coating, printing, spraying, slot-coating, roll-coating, slide-coating, blade-coating, gravure-coating or wire bar-coating.

Drying the coating layer may be carried out under heat. During drying it, while solvent is removed from it, liquid crystal molecules therein are aligned in a preferred state.

Next, the layer is irradiated with UV light to carry out polymerization reaction, and then the alignment state is immobilized to form an optically anisotropic layer. The irradiation energy is preferably from 20 mJ/cm² to 50 J/cm², more preferably from 100 mJ/cm² to 800 mJ/cm². For promoting the optical polymerization, the light irradiation may be attained under heat.

The thickness of the optically anisotropic layer may be from 0.1 to 10 micro meters or from 0.5 to 5 micro meters.

### 3. Polarizing Plate:

The invention also relates to a polarizing plate comprising at least the polymer film of the invention or the retardation film of the invention, and a polarizing film. In incorporating the polarizing plate of the invention into a liquid-crystal display device, preferably, the polymer film or the retardation film of the invention is arranged on the liquid-crystal cell side. In an embodiment having the retardation film of the invention, preferably, the back (on which the optically anisotropic layer is not formed) of the polymer film of the invention serving as a support is stuck to the surface of the polarizing film. In any embodiment, preferably, the polymer film of the invention and the polarizing films are stuck in such a manner that the crossing angle between the in-plane slow axis of the polymer film and the transmission axis of the polarizing film is nearly 0 degree. The crossing angle needs not be strictly 0 degree, and an acceptable error of around ±5 degrees in production does not have any influence on the effect of the invention, but is acceptable here. Preferably, a protective film such as a cellulose acylate film or the like is stuck to the other surface of the polarizing film.

FIG. 2 shows a schematic cross-sectional view of one embodiment of the polarizing plate of the invention. The polarizing plate 15 shown in FIG. 2 comprises a polarizing film 13 and has, on the surfaces thereof, a retardation film 10 of the invention and a protective film 14 for protecting the polarizing film 13. The support 12 to constitute the retardation film 10 is the polymer film of the invention, and the back thereof, or that is, the side thereof on which the optically anisotropic layer 11 is not formed is stuck to the surface of the polarizing film 13. When the polarizing plate 15 is incorporated into a liquid-crystal display device, the retardation film 10 is arranged to face the liquid-crystal cell side. Though not shown, the polarizing plate 15 in FIG. 2 may have any other functional layer. For example, a diffusion layer, an antiglare layer and the like may be formed on the protective film 14.

The other members than the polymer film or the retardation film of the invention to constitute the polarizing plate of the invention are described below along with various materials usable for their production.

Polarizing Film

Examples of a polarizing film (polarizer) include an iodine-base polarizing film, a dye-base polarizing film with a dichroic dye, and a polyene-base polarizing film, and any of these is usable in the invention. The iodine-base polarizing film and the dye-base polarizing film are produced generally by the use of polyvinyl alcohol films.

Protective Film

As the protective film to be bonded to the other surface of the polarizing film, preferably used is a transparent polymer film. “Transparent” means that the film has a light transmittance of at least 80%. As the protective film, preferred are cellulose acylate films, and polyolefin films containing polyolefin(s). Of cellulose acylate films, preferred are cellulose triacetate film. Of polyolefin films, preferred are cyclic polyolefin-containing polynorbornene films.

The thickness of the protective film is preferably from 20 to 500 micro meters, or from 50 to 200 micro meters.

Light-Scattering Film

The polarizing plate of the invention may contain a light-scattering film disposed on one surface of the polarizing film. The light-scattering film may be a single layer film, or multilayered film. One example of the multilayered film is a light-scattering film containing a light transmissive film and a light-scattering layer disposed on thereon. The light-scattering film may contribute to improving the viewing angle characteristics when the viewing angle is inclines in the vertical and horizontal directions. In an embodiment where the antireflection layer is disposed outside the polarizing film disposed on the displaying side, the light-scattering film may exhibit an especially high effect. The light-scattering film (or the light scattering layer contained in the film) may be formed of a composition containing fine particles dispersed in a binder. The fine particles may be inorganic particles or organic particles. Preferably, the difference in the refractive index between the binder and the fine particles is from 0.02 to 0.20 or so. The light-scattering film (or the light scattering layer contained in the film) may additionally have a hard coat function. Regarding the light-scattering film usable in the invention, referred to are JPA No. hei 11-38208 where a front scattering coefficient is specifically defined; JPA No. 2000-199809 where the relative refractive index of transparent resin and fine particles is specifically defined to fall within a specific range; and JPA No. 2002-107512 where the haze value is defined to be at least 40%.

### Production Method for Polarizing Plate:

The polarizing plate of the invention may be produced as a long polarizing plate. For example, using the polymer film of the invention formed as a long film, an alignment film-forming coating liquid is optionally applied on its surface to form an alignment film thereon, and subsequently, an optically anisotropic layer-forming coating liquid is continuously applied thereto and dried to make the formed film have a desired alignment state, and thereafter this is irradiated with light to fix the alignment state to form an optically anisotropic layer, thereby producing a long retardation film of the invention. Subsequently, the retardation film may be once wound up into a roll. Separately, a long polarizing film and a long polymer film for protective film are individually wound up into a roll; and these are stuck in a mode of roll-to-roll operation to thereby produce a long polarizing plate. The long polarizing plate is, for example, transported and stored as a roll thereof; and when incorporated into a liquid-crystal display device, it is cut into a predetermined size. The polarizing plate of the invention needs not be a long product, and the production method described here is merely one example.

In producing the polymer film of the invention, when it is stretched in the machine direction, then it may be roll-to-roll worked to produce a polarizing plate; and the embodiment is favorable as simplifying the production process and as further enhancing the axial accuracy in sticking the film to a polarizing film.

### 4. Liquid-Crystal Display Device:

The polymer film, the retardation film and the polarizing plate of the invention are usable in various modes of liquid-crystal display devices. These are usable in any of transmission-type, reflection-type or semitransmissive-type liquid-crystal display devices. The polymer film, the retardation film and the polarizing plate of the invention are usable in various modes of liquid-crystal display devices. These are usable in any of transmission-type, reflection-type or semitransmissive-type liquid-crystal display devices. The polymer film of the invention is excellent in light-resistance and is colorless; and therefore, it does not bring about any unfavorable discoloration caused by the polymer film, and contributes toward improving the viewing angle characteristics of liquid-crystal display devices.

In particular, the retardation film of the invention is effective in a liquid-crystal display device comprising a pair of substrates which are placed oppositely to each other and at least one of which has an electrode, and containing a nematic liquid-crystal material sandwiched between the pair of substrates, in which the liquid-crystal molecules of the nematic liquid-crystal material are aligned nearly vertically to the surface of the pair of substrates at the time of black level of display, especially a twist nematic (TN) mode liquid-crystal display device. In particular, the invention is effective in an embodiment of a transmission-type twisted nematic mode liquid-crystal display device.

In such a TN-mode liquid-crystal display device, preferably, two retardation films of the invention are arranged symmetrically to the liquid-crystal cell positioned at the center, and also preferably, the polarizing plates of the invention are arranged as upper and lower polarizing plates (on the viewers' side and on the backlight side) symmetrically to the liquid-crystal cell positioned at the center. The product of the thickness, d (micron), and the refractivity anisotropy, Δn, of the liquid-crystal layer of the TN-mode liquid-crystal cell, Δn·d, is generally from 0.1 to 1.5 micro meters or so.

FIG. 3 shows a schematic cross-sectional view of a TN-mode liquid-crystal display device that is one embodiment of the liquid-crystal display device of the invention. The liquid-crystal display device shown in FIG. 3 comprises a TN-mode liquid-crystal cell 16, and two polarizing plates 15 of the invention as arranged symmetrically to sandwich the cell 16 therebetween. The liquid-crystal cell 16 has a liquid-crystal layer formed of a nematic liquid-crystal material; and the liquid-crystal layer is so designed that it is in a twisted alignment state under no driving voltage application thereto, and is in a vertical alignment state to the substrate surface under driving voltage application thereto. The upper and lower polarizing plates 15 are so arranged that the transmission axes of their polarizing films 13 are vertical to each other; and therefore, in no driving voltage application, the linearly polarized light coming in the liquid-crystal cell 16 from the backlight (not shown) arranged at the back of the lower polarizing plate 15 rotates by 90° along the twisted alignment of the liquid-crystal layer, and then passes through the transmission axis of the upper polarizing plate 15 to give the white state. On the other hand, in driving voltage application, the linearly polarized light coming in the liquid-crystal cell 16 directly passes through the cell 16 while keeping its polarization state, and therefore, this is blocked by the upper polarizing plate 15 to give the black state. The retardation films 10 arranged on and below the liquid-crystal cell 16 compensates for birefringence occurring in oblique directions in the black state.

### Liquid-Crystal Display Device of Preferred Embodiment of the Invention:

Preferably, the liquid-crystal display device of the invention is a TN-mode liquid-crystal display device comprising a liquid-crystal cell and a polarizing plate arranged on at least one side of the liquid-crystal cell, in which the liquid-crystal cell includes red, green and blue color filters and liquid-crystal layers corresponding to the red, green and blue color filters, respectively, and the liquid-crystal layers have a multi-gap structure satisfying a relationship of dR≧dG>dB, or dR>dG≧dB, and the polarizing plate comprises a polarizing film and the optically compensatory film of the invention arranged on the liquid-crystal cell side of the polarizing film. Having the constitution, the liquid-crystal display device enjoys the advantageous effect of the invention mentioned above, and can prevent white color shift to occur in sideways directions. The embodiment of the liquid-crystal display device of the invention that comprises a liquid-crystal cell having such a multi-gap structure will be hereinunder referred to as “liquid-crystal display device of a preferred embodiment of the invention”.

The liquid-crystal display device of the preferred embodiment of the invention preferably has polarizing plates arranged on both sides of the liquid-crystal cell therein, in which, more preferably, the polarizing plates arranged on both sides of the liquid-crystal cell each comprises the optically compensatory film of the invention and a protective layer.

In the liquid-crystal display device of the preferred embodiment of the invention, the liquid-crystal layer has a multi-gap structure, and therefore, depending on the thickness of the liquid-crystal layer corresponding to the individual color filters, retardation differs. As a whole of the liquid-crystal layer, the liquid-crystal layer could have a larger retardation at a longer wavelength, or that is, could have so-called reversed wavelength dispersion characteristics of retardation.

When the liquid-crystal layer having reversed wavelength dispersion characteristics of retardation is combined with the retardation film of the invention, then the light intensity to run on the viewing side of the liquid-crystal display device is constant irrespective of the wavelength; and therefore, the device enjoys the advantageous effect of the invention mentioned above, and can prevent white color shift to occur in sideways directions. The details of the constituent members of the liquid-crystal display device of the preferred embodiment of the invention are described below; however, the invention is not limited to the following specific embodiments.

The liquid-crystal cell includes red, green and blue color filters, and liquid-crystal layers corresponding to the red, green and blue color filters, respectively. Preferably, the liquid-crystal layer is sandwiched between the first substrate and the second substrate. Preferably, the color filter is formed on the first substrate. On the second substrate, preferably formed are a TFT element for controlling the electro-optical properties of liquid crystals, and a scanning line for giving a gate signal to the active element and a signal line for giving a source signal thereto.

In the liquid-crystal display device of the preferred embodiment of the invention, the color filter may be formed on any side of the first substrate or the second substrate.

The color filter for use in the liquid-crystal display device of the preferred embodiment of the invention may be any one having three primary color filters of red, green and blue filters. The color filter may further have any other color filter of a deep red filter. Preferably, the red filter has a maximum value of transmittance within a wavelength range of from 400 nm to 480 nm, the green filter has a maximum value of transmittance within a wavelength range of from 520 nm to 580 nm, and the blue filter has a maximum value of transmittance within a wavelength range of from 590 nm to 780 nm. The maximum value of transmittance of each color is preferably at least 80%.

The thickness of the color filter is suitably selected. Preferably, the thickness is from 0.4 to 4.0 micro meters, more preferably from 0.7 to 3.5 micro meters. As the pixel pattern of the color filter, employable is any pattern of stripes, mosaics, triangles, blocks, etc.

In the pixel part of the color filer, if desired, a black matrix may be arranged in the boundary between different color filters, or a protective layer may be arranged to cover the color filter, or a transparent conductive film may be arranged on the protective layer.

The color material to form the color filter is not specifically defined. For example, employable are dyes and pigments. Dye-based color filters are excellent in transparency and contrast and are characterized by having a lot of spectral variations. On the other hand, pigment-based color filters are excellent in heat resistance and lightfastness. For forming the color filters, for example, employable are a photolithography method, an etching method, a printing method, an electrodeposition method, an inkjet method, a vapor evaporation method, etc.

Preferably, the color material to form the color filter is pigment. The pigment-based color filter may be formed of a color resin prepared by dispersing pigment in a binder resin such as acrylic or polyimide resin. The pigment includes, for example, Color index Generic Name: Pigment Red 177 (crimson lake), Pigment Red 168, Pigment Green 7 (phthalocyanine green), Pigment Green 36, Pigment Blue 15 (phthalocyanine blue), Pigment Blue 6, Pigment Yellow 83 (azo yellow), etc. For color control, different color pigments may be mixed and combined for use herein.

Regarding the dispersion condition of the pigment, the mean particle size of the secondary particles of the pigment is preferably at most 0.2 micro meters, more preferably at most 0.1 micro meters. The secondary particles are aggregates of some fine pigment particles (primary particles. The pigment-based color filter having such a dispersion condition may have a high transmittance and have little negative influence on polarizability.

The liquid-crystal layers to be in the liquid-crystal display device of the preferred embodiment of the invention have a multi-gap structure satisfying a relationship of dR≧dG>dB, or dR>dG≧dB in point of the thickness of the layer corresponding to each color filter. dR, dG and dB each mean the thickness of the liquid-crystal layer corresponding to the red, green and blue color filters, respectively. Most preferably, the thickness of the liquid-crystal layers corresponding to the respective color filters satisfies dR>dG>dB. However, in case where dR=dG and dG>dB, the light leakage from the liquid-crystal display device in a blue region that may have some significant influence could be reduced, and therefore the device of the type could have relatively good display characteristics. In case where dG=dB and dR>dG, similarly the device is relatively good.

(dR-dG) and (dG-dB) each are preferably from 0.1 to 1.5 micro meters, more preferably from 0.5 to 1.2 micro meters. Preferably, dR is from 2.8 to 7.9 micro meters, dG is from 2.7 to 5.7 micro meters, and dB is from 2.6 to 5.6 micro meters.

Preferably in the liquid-crystal display device of the invention, dR and dB satisfy 0 micro meter<dR-dB 3.0 micro meters, as further reducing the white color shift in sideways directions.

More preferably, the multi-gap structure of the liquid-crystal layers satisfies 0.2 micro meters≦dR-dB≦3.0 micro meters, even more preferably 1.0 micro meter≦dR-dB≦2.5 micro meters.

Any suitable method is employable for forming the multi-gap structure. Preferably, the multi-gap structure is formed by changing the thickness of the red, green and blue color filters individually. Regarding the thickness of the color filters, preferably, blue of the three primary colors is the thickest, next green is thicker, and red is thinnest. The thickness of the color filters may be changed by increasing or decreasing the amount of the color resin to be coated in case where a photolithography method or an etching method is selected. In case where an electrodeposition method or a vapor evaporation method is selected, the dipping time in the electrodeposition liquid or the vapor evaporation time may be varied to thereby control the thickness of the color filters.

In another method, the multi-gap structure may be formed by providing an undercoat layer on the first substrate side of the individual color filters, and changing the thickness of the undercoat layer corresponding to the color of the color filter. In still another method, the multi-gap structure may be formed by providing an overcoat layer on the liquid-crystal layer side of the individual color filters, and changing the thickness of the overcoat layer corresponding to the color of the color filter. In this, the overcoat layer may serve also as the protective layer for the color filter.

The thickness of the individual color filters may be the same or may differ for different color. In this case, the multi-gap structure may be formed by suitably controlling the thickness of the undercoat layer or the overcoat layer. The liquid-crystal cell for use in the liquid-crystal display device of the preferred embodiment of the invention may have both the undercoat layer and the overcoat layer, or may have the undercoat layer and/or the overcoat layer only in some color filters of the red, green and blue color filters.

The material to form the undercoat layer and the overcoat layer is preferably one excellent in transparency and heat resistance. The material includes, for example, polyimide resins, and UV-curable resins such as acrylic resins and epoxy resins.

Regarding the wavelength dispersion characteristics of retardation of the liquid-crystal layer, preferably, the layer has reversed wavelength dispersion characteristics of retardation; and the liquid-crystal layer of the type is effective for reducing the light leakage in a blue region that has heretofore been a cause of display characteristics degradation.

### 5. Measurement Method

The methods for measuring some properties such as optical properties are described in detail below.

### (1) Re and Rth

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments).

When a film to be analyzed is expressed by a monoaxial or biaxial index ellipsoid, Rth(λ) of the film is calculated as follows.

Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to the following formulae (1) and (2):

$$\begin{matrix}Re ( θ ) = [ nx - \frac{( ny \times nz )}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \\ & ( 1 ) \\ Rth = ( \frac{nx + ny}{2} - nz ) \times d & ( 2 )\end{matrix}$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

In the description, the measurement wavelength for Re or Rth is λ=550 nm in the visible light region, unless otherwise specifically noted. And in the description, the numerical data, the numerical range and the qualitative expression (for example, “equivalent”, “same”, etc.) indicating the optical characteristics should be so interpreted as to indicate the numerical data, the numerical range and the qualitative expression that include the error range generally acceptable for liquid-crystal display devices and their component parts.

### 6. Ultraviolet Absorber

The present invention relates also to an ultraviolet absorber comprising (preferably consisting essentially of) at least one merocyanine compound having λₘₐₓ of not longer than 375 nm, and at least one compound represented by formula (II). On preferable embodiment is the ultraviolet absorber wherein the residual amounts of the at least one merocyanine compound having λₘₐₓ of not longer than 375 nm and the at least one compound represented by formula (II) are equal to or more than 80% respectively after being subjected to an irradiation of light with an irradiance of 150 W/m² for 200 hours. Preferable examples of the merocyanine compound having λₘₐₓ of not longer than 375 nm and the compound represented by formula (II) are same as described above.

The ultraviolet absorber of the invention exhibits not only a good ultraviolet absorbing ability but also higher light-resistance compared with the conventional merocyanine-series ultraviolet absorbers. Namely, the ultraviolet absorber of the invention exhibits smaller decrease in the ultraviolet absorbing ability by irradiation with light compared with the conventional merocyanine-series ultraviolet absorbers.

The ultraviolet absorber of the invention is useful as an ultraviolet absorber for polymer films. The ultraviolet absorber of the invention is useful also as an ultraviolet absorber for liquids, powders and solids to be used in various usages such as glass plates, glass containers, plastic substrates, plastic containers, fibers, papers, inks, paints and architectural materials. The ultraviolet absorber of the invention may be used by mixing any matrix formed of any material and having any shape. The ultraviolet absorber of the invention may be dispersed or dissolved in the matrix, or adsorbed chemically or physically on the matrix.

### EXAMPLES

Paragraphs below will further specifically describe features of the present invention, referring to Examples and Comparative Examples. Any materials, amount of use, ratio, details of processing, procedures of processing and so forth shown in Examples may appropriately be modified without departing from the spirit of the present invention. Therefore, it is to be understood that the scope of the present invention should not be interpreted in a limited manner based on the specific examples shown below.

### Example (Example 1) of Producing Polymer Film (Cellulose Acylate Film)

### (1-1) Preparation of Dope

A cellulose acetate solution having a following formulation, containing an oligomer was prepared.

Formulation of Cellulose Acetate Solution

| | | |
|---|---|---|
| Cellulose Acetate having a mean degree of substitution | 100.0 | mas.pts. |
| of 2.86 | | |
| Methylene Chloride (first solvent) | 475.9 | mas.pts. |
| Methanol (second solvent) | 113.0 | mas.pts. |
| Butanol (third solvent) | 5.9 | mas.pts. |
| Silica Particles having a mean particle size of 16 nm | 0.13 | mas.pts. |
| (AEROSIL R972, by Nippon Aerosil) | | |
| Compound A1 | 1.8 | mas.pts. |
| (Merocyanine compound having λₘₐₓ of not longer | 1.8 | mas.pts. |
| than 375 nm) Compound B1 | | |
| (Compound represented by formula (II)) Oligomer | 15 | mas.pts. |
| (having a formulation shown in the following table) | | |

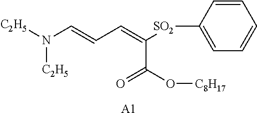

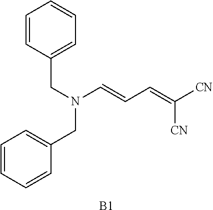

The prepared solution was cast on the mirrored surface of a support, which was a drum having a diameter of 3m, through a casting die under the PIT-draw condition shown in the following table.

When the residual solvent amount and the film surface temperature of the web on the support became the values shown in the following table, the web was stretched along the TD at the stretching ratio shown in the following table. The TD stretching was performed according to the manner that both edges of the web were grasped with pins and stretched along the direction perpendicular to the MD.

When the residual solvent amount became the value shown in the following table after the stretching, the web was subjected to the heat treatment at the temperature shown in the following table. The heat-treatment was performed while the temperature of the dry air in the drying zone was controlled. And the heat-treatment was performed while the pin-like tenter was fixed.

The producing conditions, and the formulation of the used oligomer, and the optical properties of the produced film are shown in the following tables. The Re is shown in the following table as the positive value for the direction perpendicular to the casting direction.

| Formulation | Merocyanine | A1 (parts by mass) | | 1.8 |
|---|---|---|---|---|
| | Compound | B1 (parts by mass) | | 1.8 |
| | Formulation of | Dicarboxylic | TPA | 50 |
| | Oligomer | acid | PA | 0 |
| | | Unit*¹ | AA | 50 |
| | | | SA | 0 |
| | | Diol Unit*² | EG | 50 |
| | | | PG | 50 |

| | | Molecular Weight*³ | 1000 |
|---|---|---|---|
| | | Amount | 15 |
| | | (parts by mass) | |
| Properties | Re (nm) | | 15 |
| | Rth (nm) | | 100 |
| | ΔHc (J/g) | | 3 |
| | Thickness (μm) | | 80 |
| Process | Stretching | PIT draw (%) | 104 |
| | | Film Surface | 40 |
| | | Temperature (° C.) | |
| | | TD Stretching (%) | 10 |
| | Heat Treatment | Amount of Residual | 50 |
| | | Solvent (%) | |
| | | Film Surface | 80 |
| | | Temperature (° C.) | |

*¹“TPA” means terephthalic acid, “PA” means phthalic acid, “AA” means adipic acid, “SA” means succinic acid; and the mole ratio of each of them is shown in the table.
*²“EG” means ethane diol, “PG” means 1,3-propane diol, and the mole ratio of each of them is shown in the table.
*³the number-averaged molecular weight

### Examples 2-9

In Example 1, polymer films were produced in the same manner as Example 1, except that Compounds A1 and B1 were replaced as shown in the following table respectively or the amounts thereof were varied.

### Comparative Examples 1-2

In Example 1, polymer films were produced in the same manner as Example 1, except that Compounds A1 and B1 were not added as shown in the following table.

### 2. Fabrication of TN Mode Liquid Crystal Display Device

### (2)-1 Saponification of Cellulose Acetate Film:

The cellulose acetate film obtained in Example 1 was led to pass through a dielectric heating roll unit at a temperature of 60 degrees Celsius to elevate the film surface temperature to 40 degrees Celsius. Using a bar coater, an alkali solution having the following formulation was applied to it in an amount of 14 mL/m², and kept staying under a steam-type far-IR heater (by Noritake Company) heated at 110 degrees Celsius for 10 seconds. Also using a bar coater, pure water was applied to it in an amount of 3 mL/m². In this stage, the film temperature was 40 degrees Celsius. Next, this was rinsed with water using a fountain coater and dewatered with an air knife, and this operation was repeated three times. Subsequently, this was kept staying in a drying zone at 70 degrees Celsius for 2 seconds and dried therein.

Formulation of Alkali Solution for Saponification

| | |
|---|---|
| Potassium Hydroxide | 4.7 mas. pts. |
| Water | 15.7 mas. pts. |
| Isopropanol | 64.8 mas. pts. |
| Propylene glycol | 14.9 mas. pts. |
| Surfactant (C₁₆H₃₃O(CH₂CH₂O)₁₀H) | 1.0 mas. pt. |

### (2)-2 Formation of Alignment Film:

Using a #14 wire bar coater, an alignment film-forming coating liquid having the formulation mentioned below was applied onto the saponified surface of the saponified cellulose acetate film, in an amount of 24 mL/m², and dried with hot air at 100 degrees Celsius for 120 seconds. The thickness of the alignment film was 1.2 micro meters. Next, the surface of the obtained alignment layer was subjected to a rubbing treatment along the direction of 0° relative to the lengthwise direction (machine direction) of the film of 0° by using a rubbing roller of 2000 mm with a rotation frequency of 400 rpm. In this step, the transportation speed was 40 m/minute. Subsequently, the dust was removed from the rubbed surface by ultrasonic wave.

Formulation of Alignment Film-Forming Coating Liquid

| | | |
|---|---|---|
| Modified polyvinyl alcohol mentioned below | 40 | mas.pts. |
| Water | 728 | mas.pts. |
| Methanol | 228 | mas.pts. |

Modified Polyvinyl Alcohol:

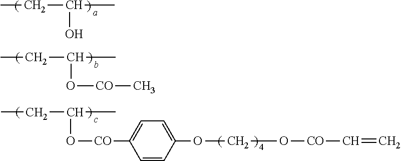

### (2)-3 Formation of Optically Anisotropic Layer:

Using a wire bar, an optically anisotropic layer-forming coating liquid having the formulation mentioned below was applied onto the rubbed surface of the alignment film after removing the dust. Next, this was heated in a thermostat bath at 130 degrees Celsius for 120 seconds whereby the discotic liquid-crystal compound was aligned. Next, using a high-pressure mercury lamp of 160 W/cm at 80 degrees Celsius, this was irradiated with UV rays for 40 seconds for crosslinking to thereby polymerize the discotic liquid-crystal compound. Subsequently, this was left cooled to room temperature.

Formulation of Optically Anisotropic Layer-Forming Coating Liquid

| | | |
|---|---|---|
| Methyl Ethyl Ketone | 270 | mas.pts. |
| Discotic Liquid-Crystal Compound shown below | 100 | mas.pts. |
| (Compound (A1)) | | |
| Fluoroaliphatic Group Containing Polymer 1 | 1.0 | mas.pt. |
| Alignment Controlling Agent 1 at Alignment Layer Side | 0.5 | mas.pts. |
| Alignment Controlling Agent 2 at Alignment Layer Side | 1.5 | mas.pts. |
| 4-Vinyl Phenyl Boronic Acid | 0.1 | mas.pts. |
| Photopolymerization Initiator (Irgacure 907, by Ciba Japan) | 3.0 | mas.pts. |
| Sensitizer (Kayacure DETX, by Nippon Kayaku) | 1.0 | mas.pt. |

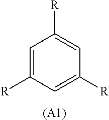

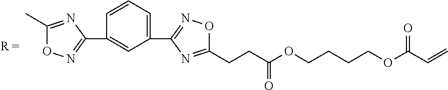

Fluroaliphatic Group Containing Polymer 1 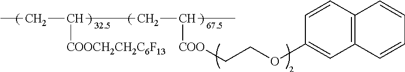
Alignment Controlling Agent 1 at Alignment Layer Side 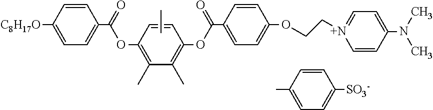
Alignment Controlling Agent 2 at Alignment Layer Side

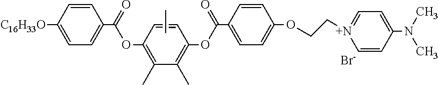

The thickness of the optically anisotropic layer was 1 micro meter. the upper and lower tilt angles were 20 and 65 degrees Celsius respectively. In this way, Retardation Film 1 was produced. Retardation Films 2-11 were produced in the same manner respectively by using the cellulose acylate films produced in Examples 2-9 and comparative Examples 1 and 2.

### (2)-4 Production of Polarizing Plate:

A polyvinyl alcohol (PVA) film having a thickness of 80 micro meters was dyed by dipping it in an aqueous iodine solution having an iodine concentration of 0.05% by mass at 30 degrees Celsius for 60 seconds, and then while dipped in an aqueous boric acid solution having a boric acid concentration of 4% by mass, this was stretched in the machine direction by 5 times the original length, and thereafter dried at 50 degrees Celsius for 4 minutes to give a polarizing film having a thickness of 20 micro meters.

The exposed face of Retardation Film 1 of cellulose acylate film produced in the above (the face thereof not coated with the optically anisotropic layer) was dipped in an aqueous sodium hydroxide solution (1.5 mol/L) at 55 degrees Celsius, and then fully washed with water to remove sodium hydroxide. Next, this was dipped in an aqueous diluted sulfuric acid solution (0.005 mol/L) at 35 degrees Celsius for 1 minute, then dipped in water to fully remove the aqueous diluted sulfuric acid solution. Finally, the sample was fully dried at 120 degrees Celsius.

The film saponified in the manner as above was combined with a commercial cellulose acetate film that had been saponified also in the same manner as above, the above-mentioned polarizing film was sandwiched between them, and these were stuck together with a polyvinyl alcohol adhesive in such a manner that the saponified surfaces of the films could face each other, thereby fabricating Polarizing Plate 1. The commercial cellulose acetate film was Fujitac TF80UL (by FUJIFILM). In this, the polarizing film and the protective film on both surfaces of the polarizing film were produced all as rolls, and therefore, the machine direction of every roll was parallel to each other, and the rolls were unrolled and continuously stuck together. Accordingly, the absorption axis of the polarizing film was parallel to the machine direction of the film roll (the casting direction in film formation). Polarizing Plates 2-11 were produced in the same manner respectively by using Retardation films 2-11.

### (2)-5 Fabrication of TN-Mode Liquid Crystal Display Device

TN-mode Liquid-Crystal Display Device 1 having the same constitution as in FIG. 3 was constructed. Concretely, in a liquid-crystal display device having a TN-mode liquid-crystal cell (Nippon Acer's AL2216W), a pair of polarizing plates were removed, and in place of them, Polarizing Plate fabricated in the above was stuck each one on both the viewers' side and the backlight side, using an adhesive, in such a manner that its optically anisotropic layer could face the side of the liquid-crystal cell. In this, the two polarizing plates were so disposed that the transmission axis of the polarizing plate on the viewers' side was perpendicular to the transmission axis of the polarizing plate on the backlight side. TN-mode Liquid-Crystal Display Devices 2-11 were fabricated in the same manner respectively by using Polarizing Plates 2-11.

### 3. Evaluation

### (3)-1 Evaluation of Light-Resistance

The obtained polymer films each were set in “Super Xenon Weather Meter SX75” (by Suga Test Instruments), and were irradiated with light under the condition of 150 W/m² for 200 hours. Then, the residual amounts of the merocyanine compound having λₘₐₓ of not longer than 375 nm and the compound represented by formula (II) in each of the polymer films were measured respectively. An optical film, which is disclosed in JP-A-2008-116788, [0080]-[0082], was disposed between the polymer film and the light source of the weather meter during the measurement. The residual ratio was calculated by assigning the obtained values to the following formulation. The results are shown in Table 2.

{(a residual amount after irradiation of light)/(a residual amount before irradiation of light)}×100

### (3)-2 Evaluation of Discolor in a Normal Direction

Regarding each of the produced liquid-crystal display devices, brightness was divided equally among eight from black to white (from the black state (L1) to the white state (L8)), and discoloration was measured at the second grade (L2) state from the black state. Discoloration of Comparative Example 1, measured under the same condition, was used as a standard value; and the difference, Δu′v′, from the standard value was calculated by the following formula, and then the difference was evaluated according to the following criterion. The results are shown in Table 2.

Δu′v′: Σ{(u′ₙ−u′_{standard})²²+(v′ₙ−v′_{standard})²}

The values of u′_{standard} and v′_{standard} in the formula represent the values of Comparative Example 1 respectively which were measured respectively under the above condition.

A: 0.0000≦Δu′v′<0.0005

B: 0.0005≦Δu′v′<0.003

C: 0.003≦Δu′v′

No discoloration was found with the naked eye in any of the polymer films used in the liquid crystal display devices, and all of them were colorless and transparent. According to the above evaluation, colorless, to be required as a film to be used in a liquid crystal display device, can be evaluated, and the evaluation above is stricter compared with a normal discoloration evaluation of a film. Therefore, “B” is a sufficiently allowable level.

TABLE 2

| | Merocyanine Compound | | | | | | | | | | |
|---|---|---|---|---|---|---|---|---|---|---|---|
| | Compound with λₘₐₓᵢ ≦ | | | Compound represented by | | | | | | | |
| | 375 nm (Compound A) | | | formula (II) (Compound B) | | | Wavelength | | | | |
| | | Amount | | | Amount | | Dispersion | Light Resistance (%) | | | |
| | Com- | (Parts | λₘₐₓ | | (Parts | λₘₐₓ | Characteristi [symbol] | Compound | Compound | | Evaluation of |
| | poun [symbol] | by mass) | (nm) | Compound | by mass) | (nm) | of Rth | A | B | Δu′v′ | Discoloration |
| Example 1 | A1 | 1.8 | 369 | B1 | 1.8 | 377 | 1.20 | 95 | 99 | 0.0010 | B |
| Example 2 | A2 | 1.8 | 369 | B1 | 1.8 | 377 | 1.20 | 95 | 99 | 0.0010 | B |
| Example 3 | A1 | 1.8 | 369 | B2 | 1.8 | 380 | 1.20 | 95 | 99 | 0.0010 | B |
| Example 4 | A1 | 2.5 | 369 | B1 | 1.0 | 377 | 1.20 | 80 | 99 | 0.0005 | B |
| Example 5 | A1 | 1.0 | 369 | B1 | 2.5 | 377 | 1.20 | 97 | 99 | 0.0020 | B |
| Example 6 | A1 | 2.5 | 369 | B1 | 2.5 | 377 | 1.25 | 95 | 99 | 0.0020 | B |
| Example 7 | A1 | 1.8 | 369 | B3 | 1.8 | 376 | 1.20 | 94 | 97 | 0.0010 | B |
| Example 8 | A1 | 1.8 | 369 | B4 | 1.8 | 387 | 1.20 | 96 | 98 | 0.0020 | B |
| Example 9 | A1 | 1.8 | 369 | B5 | 1.8 | 377 | 1.20 | 94 | 97 | 0.0010 | B |
| Comparative | A1 | 3.6 | 369 | — | — | — | 1.20 | 45 | — | 0.0000 | A |
| Example 1 | | | | | | | | | | | |
| Comparative | — | — | — | B1 | 3.6 | 377 | 1.20 | — | 99 | 0.0030 | C |
| Example 2 | | | | | | | | | | | |

[symbol]

indicates data missing or illegible when filed

Compounds A1-A2 and Compounds B1-B5 in Table 2 are shown below.

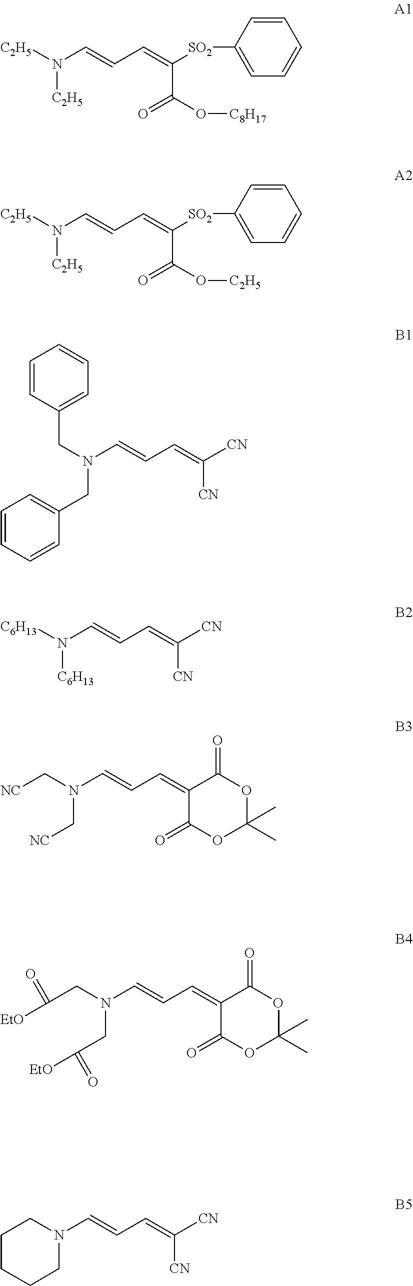

From the results shown in the above table, it is understandable that the polymer films of the invention, containing a merocyanine compound having λₘₐₓ of not longer than 375 nm, and a compound represented by formula (II), are excellent in light-resistance, and discoloration thereof is reduced.

1. A polymer film comprising:
at least one merocyanine compound having λₘₐₓ of not longer than 375 nm, and
at least one compound represented by formula (II), which is different from said at least one merocyanine compound: 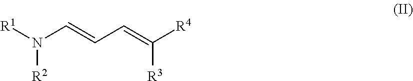
wherein, in formula (II), R¹ and R² each independently represent a hydrogen atom, alkyl group, aryl group, heterocyclic group, cyano, N-alkyl- or N-aryl-carbamoyl group, aryloxy carbonyl group or —CH₂COOR⁵, or R¹ and R² bind to each other to form a ring containing a nitrogen atom, these groups and rings may have one or more substituents if possible; R⁵ represents an alkyl group, aryl group or a heterocyclic group; R³ and R⁴ each independently represent a substituent having a Hammett substituent constant σp of equal to or more than 0.2, or R³ and R⁴ bind to each other to form a cyclic active methylene compound structure, and these groups and rings may have one or more substituents if possible.

2. The polymer film of claim 1, wherein said at least one merocyanine compound having λₘₐₓ of not longer than 375 nm is a compound represented by formula (I): 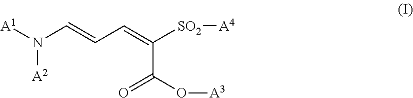
wherein, in formula (I), A¹, A², A³ and A⁴ each independently represent a hydrogen atom, alkyl group, alkenyl group or aryl group, or A¹ and A² bind to each other to form a ring, and these groups and rings may have one or more substituents if possible.

3. The polymer film of claim 1, wherein the residual amounts of the at least one merocyanine compound having λₘₐₓ of not longer than 375 nm and the at least one compound represented by formula (II) are equal to or more than 80% respectively after being subjected to an irradiation of light with an irradiance of 150 W/m² for 200 hours.

4. The polymer film of claim 2, wherein the compound represented by formula (I) is a compound represented by formula (I-a): 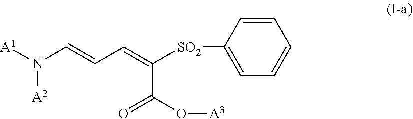
wherein, in formula (I-a), the definitions of A¹, A² and A³ are same as those of A¹, A² and A³ in formula (I) respectively.

5. The polymer film of claim 1, wherein the at least one compound represented by formula (II) is a compound represented by formula (II-a), (II-b), (II-c), or (II-d): 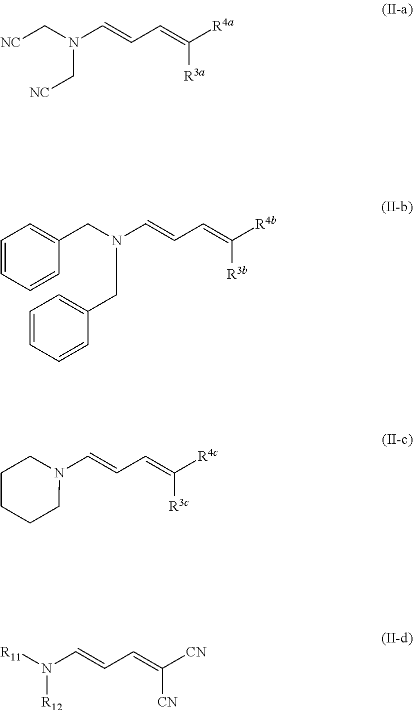
wherein, in formulas (II-a), (II-b), and (II-c), the definitions of R^{3a}, R^{3b} and R^{3c} are same as that of R³ in formula (II); and the definitions of R^{4a}, R^{4b} and R^{4c} are same as that of R⁴ in formula (II); and, in formula (II-d), the definitions of R¹¹ and R¹² are same as those of R¹ and R² in formula (II).

6. The polymer film of claim 1, wherein, in formula (II), R³ and R⁴ each independently represent a substituted or non-substituted alkyl- or aryl-carbonyl group, a substituted or non-substituted alkyl- or aryl-oxycarbonyl group, a substituted or non-substituted N-alkyl- or N-aryl-carbamoyl group or cyano, or R³ and R⁴ bind to each other to form a ring selected from Cyclic Active Methylene Group (I):
Cyclic Active Methylene Group (I) 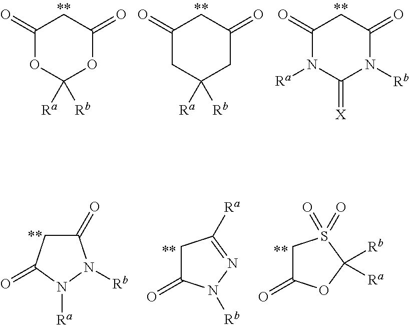
wherein each of “**” indicates the position at which the group binds to formula (II); R^{a} and R^{b} each represent a hydrogen atom, a substituted or non-substituted alkyl group or a substituted or non-substituted phenyl group, or R^{a} and R^{b} bind to each other to form a ring structure; and X represents an oxygen atom or a sulfur atom.

7. The polymer film of claim 1, wherein the at least one compound represented by formula (II) has λₘₐₓ of not shorter than 350 nm.

8. The polymer film of claim 1, wherein a total amount of the at least one compound, having λₘₐₓ of not longer than 375 nm, is from 0.2 to 10 parts by mass with respect to the total of the polymer film.

9. The polymer film of claim 1, wherein a total amount of the at least one compound represented by formula (II) is from 0.2 to 10 parts by mass with respect to the total of the polymer film.

10. The polymer film of claim 1, wherein a ratio by mass of the at least one compound represented by formula (II) to the at least one compound, having λₘₐₓ of not longer than 375 nm, is from 5/1 to 2/5.

11. A retardation film comprising:
a polymer film of claim 1, and
an optically anisotropic layer of a cured liquid crystal composition.

12. A polarizing plate comprising:
a polymer film of claim 1, and
a polarizing film.

13. A polarizing plate comprising
a retardation film of claim 11, and
a polarizing film.

14. A liquid crystal display device comprising a retardation film of claim 1.

15. An ultraviolet absorber comprising:
at least one merocyanine compound having λₘₐₓ of not longer than 375 nm, and
at least one compound represented by formula (II), which is different from said at least one merocyanine compound: 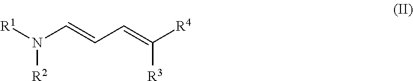
wherein, in formula (II), R¹ and R² each independently represent a hydrogen atom, alkyl group, aryl group, heterocyclic group, cyano, N-alkyl- or N-aryl-carbamoyl group, aryloxy carbonyl group or —CH₂COOR⁵, or R¹ and R² bind to each other to form a ring containing a nitrogen atom, these groups and rings may have one or more substituents if possible; R⁵ represents an alkyl group, aryl group or a heterocyclic group; R³ and R⁴ each independently represent a substituent having a Hammett substituent constant σp of equal to or more than 0.2, or R³ and R⁴ bind to each other to form a cyclic active methylene compound structure, and these groups and rings may have one or more substituents if possible.
